(19) United States
(12) Patent Application Publication
(10) Pub. No.: US 2012/0206408 A1
(43) Pub. Date: Aug. 16, 2012

(54) LIQUID CRYSTAL DEVICE COMPRISING ARRAY OF SENSOR CIRCUITS USING A PRE-CHARGE OPERATION

(75) Inventor: Christopher James Brown, Oxford (GB)

(73) Assignee: SHARP KABUSHIKI KAISHA, Osaka (JP)

(21) Appl. No.: 13/503,428

(22) PCT Filed: Nov. 1, 2010
(86) PCT No.: PCT/JP2010/069776

§ 371 Date: Apr. 23, 2012

(30) Foreign Application Priority Data
Nov. 3, 2009 (GB) 0919261.8

(51) Int. Cl. G06F 3/044; G09G 3/36

(52) U.S. Cl. 345/174; 345/87

(57) ABSTRACT

A liquid crystal device is provided, for example in the form of a combined display and sensor forming a touch screen. The device comprises an array, for example of active matrix type, of sensor circuits. Each sensor circuit comprises a liquid crystal sensing capacitor (CV) connected between a transistor M1 arranged as a source-follower and a precharging input (PRE). A sensor selecting capacitor (C1) is connected between the transistor (M1) and a row select line (RWS).

### TECHNICAL FIELD

The present invention relates to liquid crystal devices, for example for use in the field of active matrix liquid crystal displays (AMLCD) with integrated sensors. Such devices may be used for sensing a change in capacitance of a liquid crystal material upon mechanical deformation of the display for creating a touch panel function based on this measurement. Such a touch panel provides information not only about the location of a touch input event but also of the force of touch which is related, via the mechanical deformation, to the magnitude of the change in capacitance.

### BACKGROUND ART

Circuits to measure the liquid crystal capacitance may be fabricated in a thin-film polysilicon process compatible with that used in the manufacture of the TFT substrate of the AMLCD. In such a system, the pixel matrix must include both sensor and display elements and the same liquid crystal cell used for the display generates the sensor signal. Whilst it is desirable on the part of the sensor for mechanical deformation to cause a large and easily detectable change in the liquid crystal cell, such a large change has a deleterious effect on the display quality.

A liquid crystal display (LCD) is formed as shown in FIG. 1 by two opposing substrates, each patterned with a transparent conductor and separated by a gap into which is injected liquid crystal material. The distance of this gap, known as the cell-gap, is defined and maintained by a display spacer. Each unique pair of electrodes formed by the opposing transparent conductors forms a picture element (pixel) comprising a capacitor in which the liquid crystal material forms the dielectric material. It is well known that a touch panel may be formed within an LCD by providing a means of measuring the value of these liquid crystal capacitors across the display area. In these devices, an input object—such as a finger or stylus—is used apply pressure to the surface of the display resulting in mechanical deformation of the liquid crystal cell. This deformation is characterized by a change in the cell-gap—and hence a change in the value of the liquid crystal capacitance—in the region of the point at which pressure is applied. Measurement of the liquid crystal capacitance therefore provides information about the location of and pressure applied by the input object.

Methods to measure the liquid crystal capacitance within an LCD can be divided into three categories according to the circuit techniques used for the sensor: passive matrix; passive pixel; and active pixel.

In a passive matrix device, as disclosed in e.g. “Entry of data and command for an LCD by direct touch; an integrated LCD panel”, Tanaka et al., Proc. SID 1986 and shown in FIG. 2, the transparent conductors are patterned as rows and columns. Test signals are applied to the rows (or columns) and the signals generated on the columns (or rows) in response are detected to provide a measure of the liquid crystal capacitance at the intersection of each row and column. A significant disadvantage of this arrangement however is that the rows and columns must be used for both the display and sensing functions. As a result of the time sharing necessary to achieve these dual functions, the quality of the image displayed by the LCD and the accuracy of the capacitance measurement are reduced.

An alternative passive matrix arrangement is disclosed in US Patent Application US2007-0040814 (published 22 Feb. 2007) and shown in FIG. 3. In this arrangement, although the display function is achieved using an active matrix, the sensor function is achieved by integrating additional row and column addressing lines on the same active matrix substrate. In this arrangement, the liquid crystal capacitors to be measured are formed between each row or column addressing line and the common electrode on the opposing substrate. Detection circuits are provided at the output of each row and column to measure each of these capacitors. The location of the input object touching the display may then be determined by processing these measurements. Since the display and sensor functions are physically separated, it is possible to improve both the quality of the display image and the accuracy of the measured capacitance.

In more detail, a sensing unit SU is disposed between two pixels. A plurality of reset signal input units INI is provided. The output data lines OY₁-OY_{N} and OX₁-OX_{M} include the horizontal and vertical output data lines OY1-OY_{N} and OX₁-OX_{M} connected to the horizontal and vertical sensing data lines SY₁-SY_{N} and SX₁-SX_{M} through corresponding sensing signal output units SOUT. Output data lines OY₁-OY_{N} and OX₁-OX_{M} are connected to a sensing signal processing unit 800 to transmit output signals from the sensing signal output units SOUT to the sensing signal processing unit 800 which performs operations such as amplification of the read sensing data signals by respective amplifying units 810. Contact determination unit 700 receives the digital sensing signals DSN from the sensing signal processing unit 800, and processes them to determine whether contact has been made. Element 600 is a signal controller.

However, a disadvantage common to all passive matrix type sensors is that the accuracy of the capacitance that can be measured is limited by the parasitic capacitance of the row and column addressing lines. These parasitic elements attenuate the signal generated by the variable liquid crystal capacitance and make the sensor susceptible to interference and noise. In addition, passive matrix sensors require external connections to be made to each row and column, thus increasing the cost and reducing the reliability of the device.

In a passive pixel device, a matrix is formed by a plurality of individually addressable sensor pixels in which the liquid crystal capacitor element is separated from a data line by a switch, the state of which is controlled by a scan line. When the switch is activated by the corresponding scan line, the liquid crystal capacitor element is connected to the corresponding data line and its capacitance measured by a detection circuit connected to the data line. A scan driver is used to select every scan line of the matrix in turn such that the capacitance of every liquid crystal capacitor element is measured during one frame of operation. As disclosed in GB Patent Application, GB2398916 published on 1 Sep. 2004 (FIG. 4), the pixel switch and liquid crystal capacitor elements may be common to both the sensor and display with the separate functions achieved by time sharing. During a first period corresponding to the display function, the select TFT is firstly turned on and data is written to the pixel via the data line. The select TFT is then turned off and the display data stored within the pixel. During a second period corresponding to the sensor function, the select TFT is turned on and the capacitance of the pixel is measured by the detection circuits located at the end of the data line. An advantage of this arrangement is that the sensor function may be integrated into the display with no loss in display aperture ratio. A disadvantage however is that the capacitance change corresponding to an input object touching the display is very small and difficult for the detection circuits of the sensor to measure accurately.

Alternatively, as disclosed in U.S. Pat. No. 7,280,167 (published on 9 Oct. 2007) and shown in FIG. 5, the pixel liquid crystal element may be common to both display and sensor functions but additional switch transistors and addressing lines are added to the pixel and matrix to partially separate the sensor and display functions. In this arrangement, the sensor and display functions are again achieved by time sharing but, advantageously, the time available for measuring the capacitance of the pixel may be increased and hence the accuracy of the capacitance measurement may be improved.

In more detail, FIG. 5 shows gate lines Gₙ, Gₙ₋₁ etc intersecting with data lines Data that transfer image data. Signal lines 10 are insulated from and juxtaposed with the data lines. The signal lines 10 are connected to signal amplifiers 20 which compare a signal applied to each signal line and a reference voltage REF.

Switching elements TFT₁, TFT₂, TFT₃ are formed in each of a plurality of pixel regions. A drain electrode of a first switching element TFT₁ is connected to a pixel electrode P formed on a lower substrate of a liquid crystal panel, and a common electrode COM is formed on an upper substrate. A liquid crystal material is filled between the pixel electrode P and the common electrode COM and is represented by a liquid crystal capacitance Clc, and a storage capacitance Cst is provided for maintaining a voltage applied to the liquid crystal capacitance Clc.

A disadvantage common to all passive pixel type sensors is that, especially for large arrays, the liquid crystal capacitor element is small compared to the parasitic capacitance of the addressing lines and the accuracy of the capacitance measurement therefore remains low. Further, the measurement is easily affected by noise and interference from the display operation. Active pixel type sensors provide a solution to this problem through an additional amplification element arranged to generate a large pixel output signal swing from a small change in the capacitance of the liquid crystal element.

An example of an active pixel circuit is disclosed in US Patent Application US2006-0017710 (published 26 Jan. 2006) and shown in FIG. 6. In this arrangement, each pixel comprises a display part and a sensor part wherein: the display part further comprises: a data line, Dj; a scan line, Gi; a switch transistor Qs1; a liquid crystal capacitor element, CLC; and a storage capacitor, CST; and the sensor part further comprises an output line, Pj; a power supply line, Psd; a row select line, Si; a select transistor Qs2; an amplifier transistor Qp; and a variable liquid crystal capacitor element, CV.

The operation of the display part is well known and will not be described further. The operation of the sensor part of the pixel—the active pixel sensor circuit—is separate from the operation of the display part and is described as follows. When the row select line, Si, is made high, the select transistor, Qs2, is turned on and the source terminal of the amplifier transistor, Qp, is connected to the output line, Pj. The current flowing through the amplifier transistor, Qp, from the power supply line, Psd, to the output line, Pj, is determined by the voltage at the gate terminal of the amplifier transistor. This gate voltage is, in turn, determined by the capacitance of the variable liquid crystal capacitor element, CV, and may range from below the transistor threshold voltage to above it. Accordingly, the amplifier transistor may be turned off or on and the current flowing through it may consequently vary by several orders of magnitude. An advantage of this active pixel sensor circuit is therefore that a relatively small change in the liquid crystal capacitance may cause a large change in the pixel output current and the liquid crystal capacitance may be accurately measured.

An alternative active pixel sensor circuit is shown in FIG. 7. In this arrangement the sensor part of the pixel comprises: a row select line, Vct1; an amplifier transistor, M1; a select capacitor, C1, of capacitance C₁; and a variable liquid crystal capacitor, CV. The operation of this circuit is now briefly described. When the row select line is made high, charge is injected onto the gate terminal of the amplifier transistor. The voltage of the gate terminal after this charge injection, V_{G}, is determined by the capacitance of the variable liquid crystal capacitor element according to the following equation:

V_{G}=V_{G0}+(V_{RWS,H}−V_{RWS,L})·C₁(C₁+C_{V}+C_{G,M1})

where: V_{G0} is the voltage of the gate terminal before the charge injection; V_{RWS,H} and V_{RWS,L} are the high and low potentials respectively of the row select signal; C_{V} is the capacitance of the variable liquid crystal capacitor; and C_{G,M1} is the capacitance associated with the gate terminal of the amplifier transistor M1. For a small liquid crystal capacitance, the gate voltage rises above the threshold voltage of the amplifier transistor M1, turning it on. M1 now forms a source follower amplifier with a bias transistor located at the end of the data line, the output voltage of which is a measure of the capacitance of the liquid crystal capacitor element, CV. If the liquid crystal capacitance is large, the change in gate voltage due to charge injection across the select capacitor is small and the amplifier transistor remains off. It is therefore possible to produce a large change in the pixel output voltage for a relatively small change in the liquid crystal capacitance.

Although the active pixel type sensor provides a significantly more accurate measure of the liquid crystal capacitance than either the passive matrix or passive pixel types, in practice the sensitivity of the pixel output signal to changes in the capacitance of the liquid crystal capacitor elements associated with realistic mechanical deformations of the cell-gap remains too small. In order to generate a large enough output signal to be reliably detectable, the input object must press the display with a larger force than is acceptable for a touch panel operation. A well-known technique to improve this sensitivity is to increase the absolute change in capacitance for a given touch pressure by increasing the mechanical deformation of the cell-gap. This can be achieved either by reducing the thickness of the display glass substrate or by reducing the density of the display spacers defining the cell-gap. However, since the display uses the same liquid crystal cell as the sensor, a serious side-effect of this approach is that the quality of the displayed image may be severely degraded in the region around where the input object touches the display.

An alternative solution to improve the sensitivity is to provide additional spacer structures within the liquid crystal cell. The purpose of these sensor spacers is to narrow the cell-gap in the region of the sensor and thus provide an increase in the relative change in capacitance for a given input pressure. The use of sensor spacers for this purpose is known, for example as disclosed in “Embedded Liquid Crystal Capacitive Touch Screen Technology for Large Size LCD Applications”, Takahashi et al., Proc. SID 2009 and shown in FIG. 8. Whilst these structures are helpful to improve the sensitivity of the capacitance sensor, there remains a mismatch between the change in capacitance that can be comfortably generated by the user pressing the input object on the display and that which is reliably detectable by the sensor. In particular, this low sensitivity remains a problem when using input objects with a large contact area, such as a finger, where for a given input force a smaller pressure is generated than with an input object of smaller contact area, such as a stylus or pen. In addition, for applications where a measure of the pressure applied by the input object is required, the accuracy of the capacitance measurement must be higher than in the case of a touch panel where only a simple determination of a touch event is required.

Accordingly, new techniques are desirable to increase the sensitivity of the capacitance sensor without deleterious side-effects to the display.

### SUMMARY OF INVENTION

The present invention provides a liquid crystal device comprising a first array of first sensor circuits, each of which comprises an amplifier, a liquid crystal sensing capacitor connected between an input of the amplifier and a sensor circuit precharge input, and a further capacitor connected between the amplifier input and a sensor circuit selecting input.

The sensing capacitor may comprise a planar capacitor having co-planar electrodes cooperating with an adjacent layer of liquid crystal material.

The co-planar electrodes may face an electrode gap on an opposite side of the layer.

The co-planar electrodes may face an electrically floating electrode on an opposite side of the layer.

The co-planar electrodes may be surrounded by a co-planar guard ring arranged to receive a substantially fixed voltage.

The sensing capacitor may have a capacitance which changes in response to a touch event.

The precharge input may be arranged to receive a first voltage during a first precharge period and a second voltage whose value is less than that of the first voltage during a second precharge period.

The term “value” of a voltage as used herein takes into account the sign of a voltage as well as its magnitude (so that, for example, a voltage of −2V has a lower value than a voltage of −1V).

The selecting input may be arranged to receive a third voltage for inhibiting the first sensor circuit during an inhibiting period and a fourth voltage whose value is greater than that of the third voltage for enabling the first sensor circuit during an enabling period.

The enabling period may begin during the second precharge period.

The enabling period and the second precharge period may end substantially simultaneously.

The amplifier may comprise a first transistor.

The first transistor may comprise a first metal oxide semiconductor field effect transistor.

The first transistor may be connected as a source-follower.

The first array may comprise rows and columns of the first sensor circuits with the source-followers of each column of the first sensor circuits being connected to a common source load.

The selecting inputs of the first sensor circuits of each row may be connected together.

The precharge inputs of the first sensor circuits of each row may be connected together.

The further capacitor may comprise a voltage dependent capacitor.

The voltage dependent capacitor may comprise a second metal oxide semiconductor field effect transistor.

A source and drain of the second field effect transistor may be connected together.

Each of the first sensor circuits may comprise a diode having a first terminal connected to the amplifier input and arranged to provide a predetermined voltage at the amplifier input when the first sensor circuit is inhibited.

The second field effect transistor may have a source-drain path connected between the amplifier input and a first terminal of a diode arranged to provide a predetermined voltage at the amplifier input when the first sensor circuit is inhibited.

A second terminal of the diode may be connected to the precharge input.

The device may comprise a second array of liquid crystal display pixels.

The first and second arrays may be addressed by a common active matrix addressing arrangement.

The addressing arrangement may be arranged to address the first array during display blanking periods.

The first sensor circuits may have outputs connected to data input lines connected to pixel data inputs

Each of the first sensor circuits may be associated with a group of at least one of the pixels.

Each group may comprise a composite colour group of pixels.

The device may comprise a third array of second sensor circuits having sensitivities less than those of the first sensor circuits.

The second sensor circuits may be interleaved with the first sensor circuits.

The device may be arranged to operate as a touch screen.

It is possible to increase the sensitivity of capacitance measurement in a capacitance sensor array. In particular, it is possible to increase the sensitivity of a capacitance sensor array comprising active pixel sensor circuits. Such techniques are applicable to capacitance sensor arrays in general and, more specifically, to capacitance sensor arrays integrated into liquid crystal displays in which the liquid crystal material is used both as the optical element of the display and as the dielectric of the capacitor to be measured.

The sensitivity of the active pixel sensor circuit to changes in capacitance of the variable liquid crystal capacitor may be increased relative to the prior art. The following advantages arise from this feature. Firstly, it is possible to integrate a force sensitive touch panel within an AMLCD without significantly compromising the mechanical integrity of the display. As a result, touching the display causes little or no degradation in the quality of the displayed image. Secondly, the ratio of the measured signal to the noise is increased resulting in a more accurate measurement of the force of touch and a more reliable and robust operation. Additionally, for simple touch panel applications, the cost of manufacture of the AMLCD may be reduced since the need for specific in-cell structures to increase the sensitivity of the sensor is obviated by the improved active pixel sensor circuit.

Another advantage arises in embodiments where the planar structure of the sensor electrodes forms the variable liquid crystal capacitor. Compared to the prior art in which one of the electrodes forming the variable liquid crystal capacitor was common with the display operation, such embodiments, provide two electrodes unique to the sensor operation. As a result, the sensor is less susceptible to electrical noise and interference from the display operation and the accuracy of the capacitance measurement, and hence accuracy of the touch force measurement, is increased.

The foregoing and other objectives, features, and advantages of the invention will be more readily understood upon consideration of the following detailed description of the invention, taken in conjunction with the accompanying drawings.

### BRIEF DESCRIPTION OF DRAWINGS

The invention will be further described, by way of example, with reference to the accompanying drawings, in which:

FIG. 1 shows a prior art liquid crystal display having a touch panel;

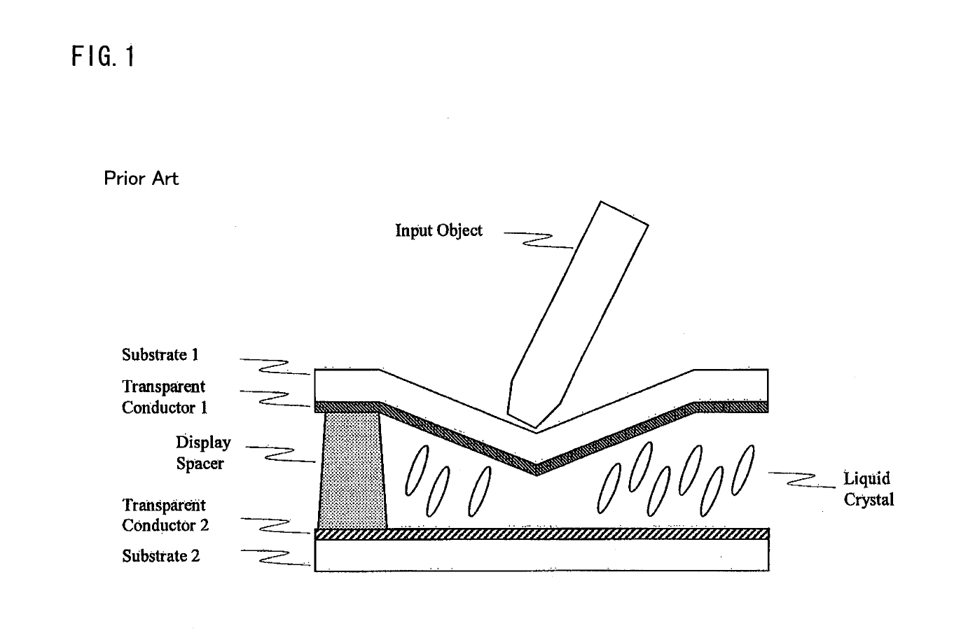

FIG. 2 shows a prior art liquid crystal display having a passive matrix sensor circuit;

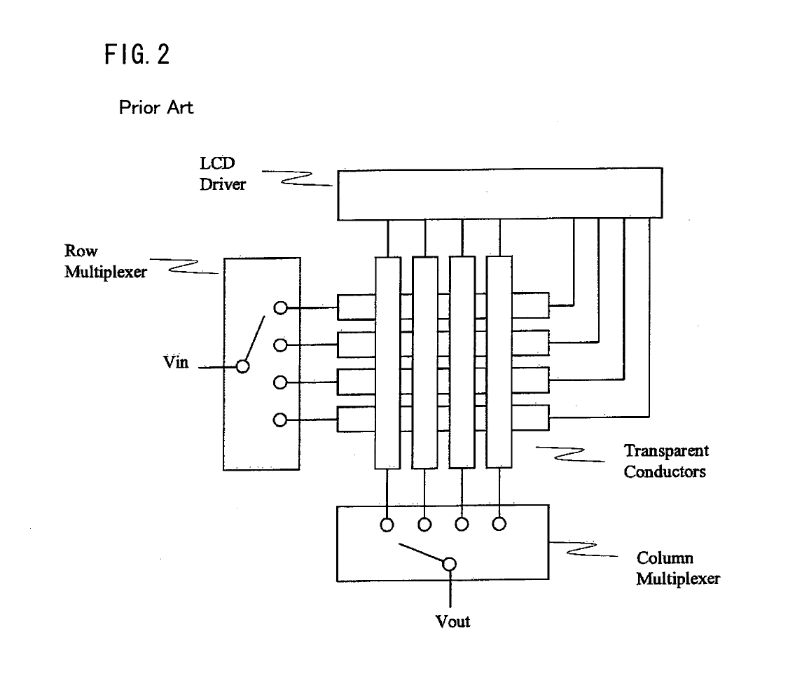

FIG. 3 shows a prior art liquid crystal display having a passive matrix sensor circuit;

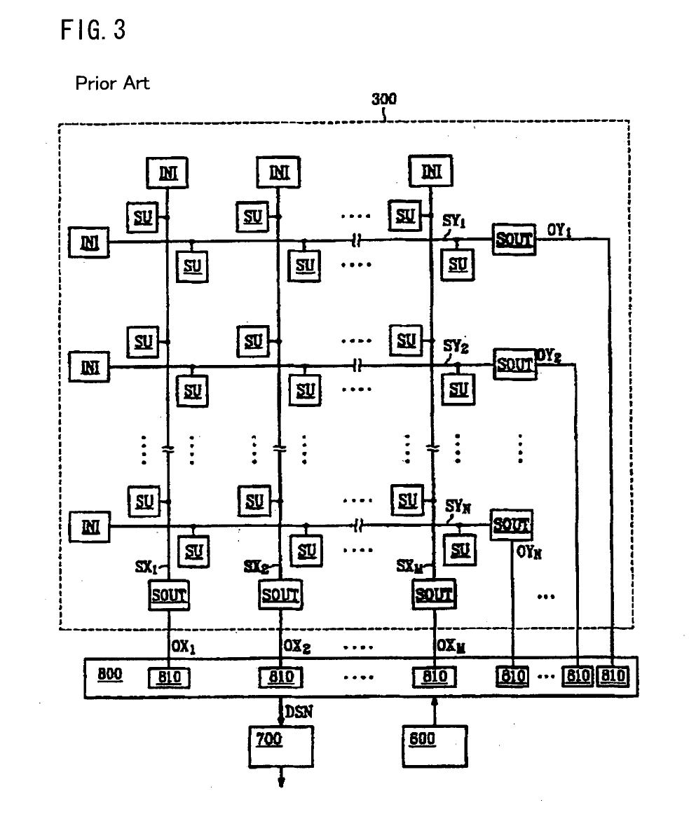

FIG. 4 shows a prior art liquid crystal display having a passive matrix sensor circuit;

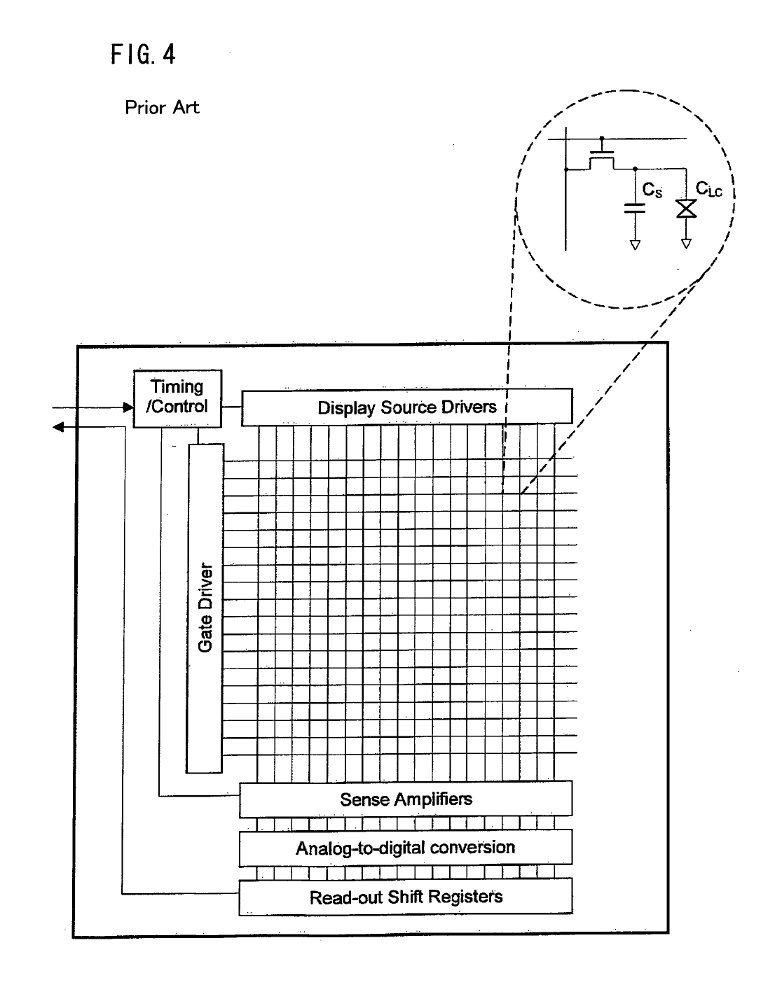

FIG. 5 shows a prior art liquid crystal display having a passive matrix sensor circuit;

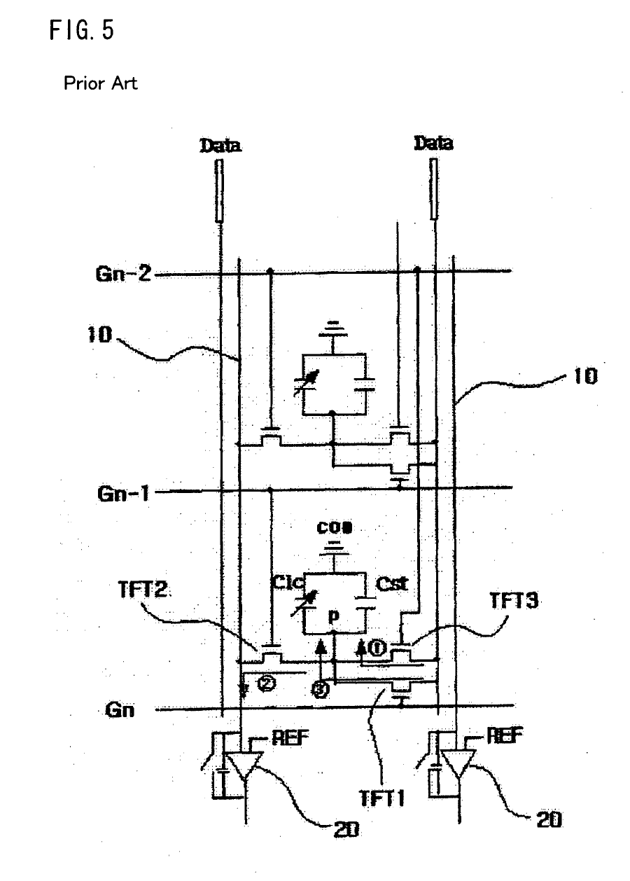

FIG. 6 shows a prior art liquid crystal display having an active pixel sensor circuit;

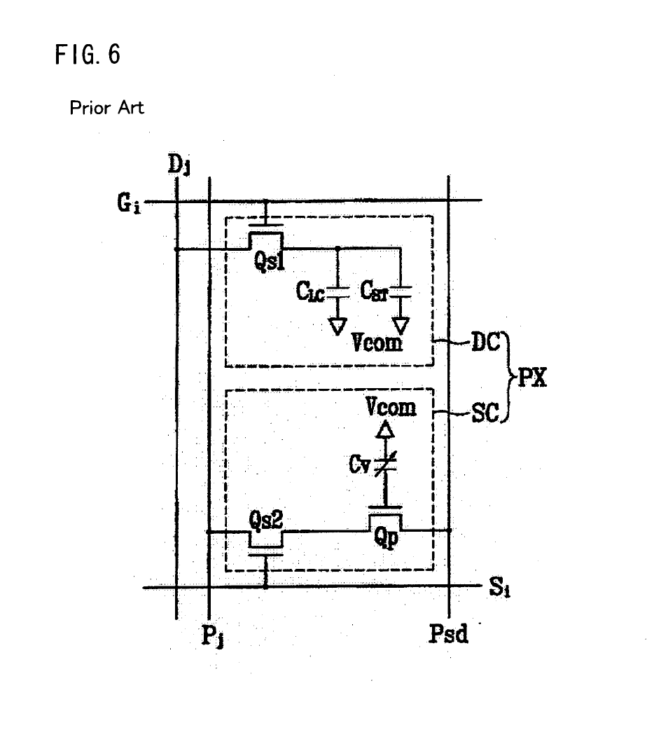

FIG. 7 shows a prior art liquid crystal display having an active pixel sensor circuit;

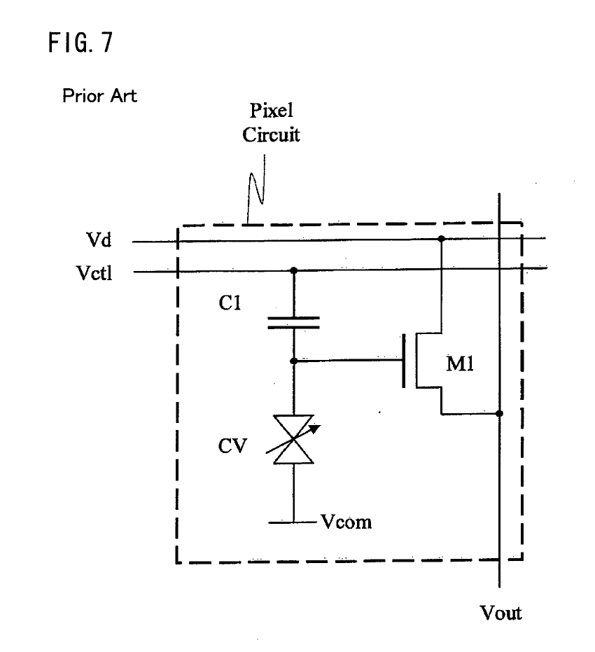

FIG. 8 shows a prior art liquid crystal display having additional spacer structures;

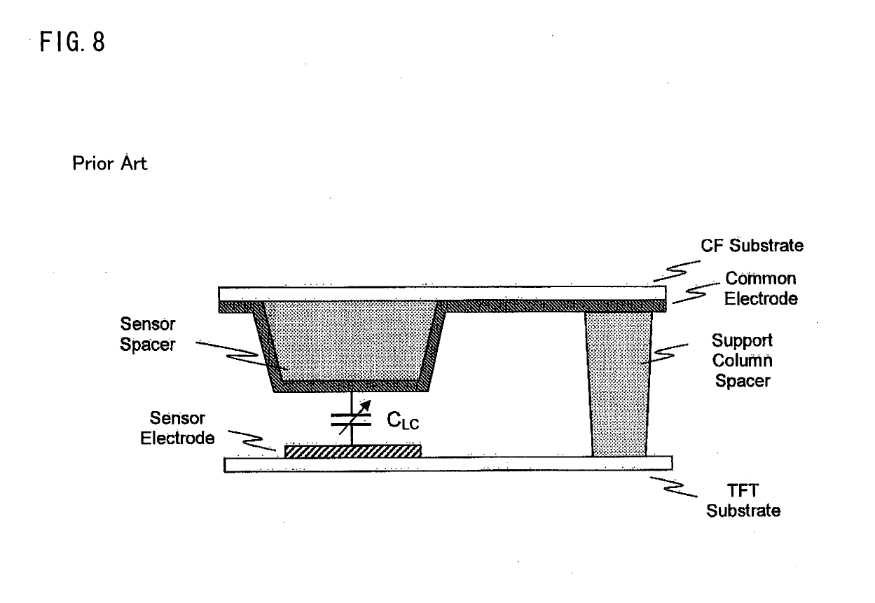

FIG. 9 shows the first and most general embodiment of the first aspect of this invention;

FIG. 10 shows the voltage-capacitance relationship exhibited by the voltage-dependent select capacitor of the first embodiment;

FIG. 11 shows a waveform diagram illustrating the operation of the first embodiment;

FIG. 12 shows the structure of the variable liquid crystal capacitor element of the first embodiment;

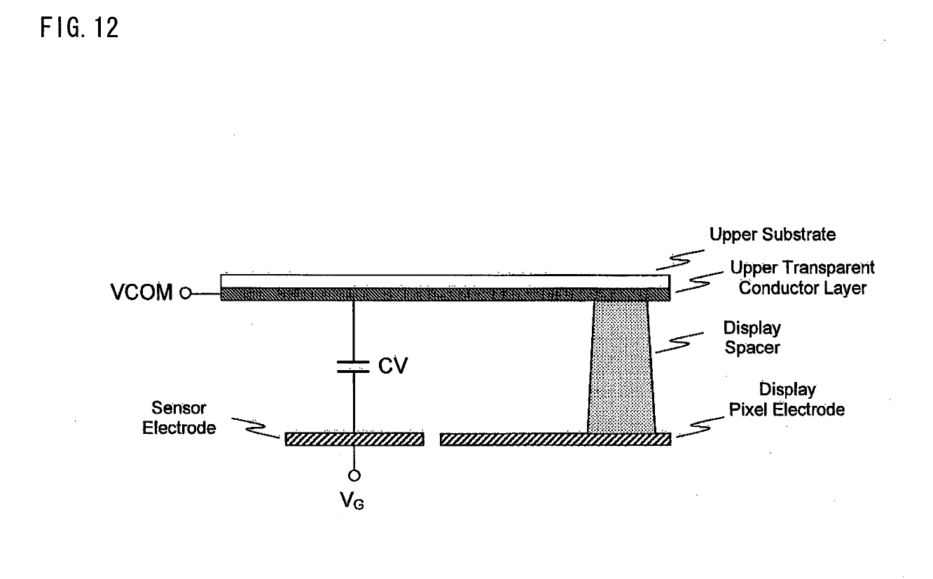

FIG. 13 shows a read-out circuit associated with the first embodiment;

FIG. 14 shows the second embodiment of this invention;

FIG. 15 shows the third embodiment of this invention;

FIG. 16 shows the fourth embodiment of this invention;

FIG. 17 shows the fifth embodiment of this invention;

FIG. 18 shows the sixth embodiment of this invention;

FIG. 19 shows the seventh embodiment of this invention, the first and most general of the second aspect;

FIG. 20 shows a waveform diagram illustrating the operation of the seventh embodiment;

FIG. 21 shows the structure of the variable liquid crystal capacitor element of the seventh embodiment;

FIG. 22 shows the eighth embodiment of this invention;

FIG. 23 shows an alternative arrangement of the eighth embodiment of this invention;

FIG. 24 shows the ninth embodiment of this invention;

FIG. 25 shows the tenth embodiment of this invention;

FIG. 26 shows the eleventh embodiment of this invention;

FIG. 27 shows a waveform diagram illustrating the operation of the eleventh embodiment;

FIG. 28 shows the twelfth embodiment of this invention;

FIG. 29 shows a waveform diagram illustrating the operation of the twelfth embodiment;

FIG. 30 shows the general concept of the third aspect of the invention;

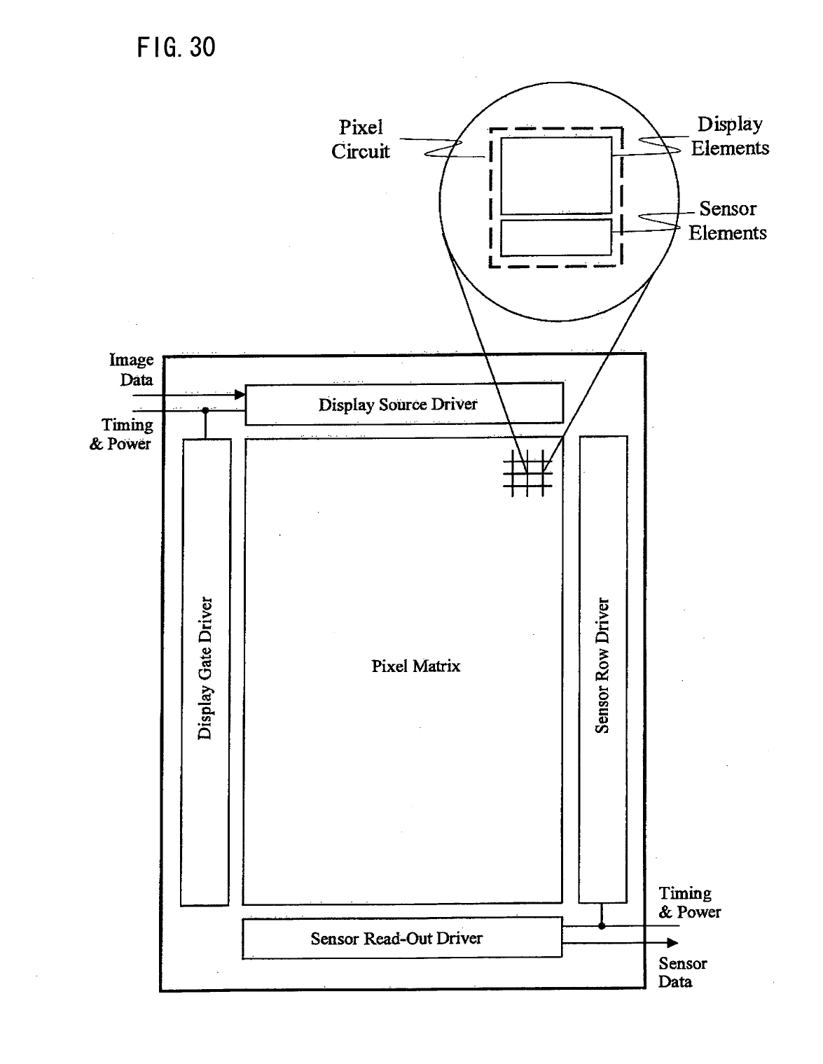

FIG. 31 shows the thirteenth embodiment of this invention, the first of the third aspect;

FIG. 32 shows the fourteenth embodiment of this invention;

FIG. 33 shows the fifteenth embodiment of this invention;

FIG. 34 shows a waveform diagram illustrating the operation of the sixteenth embodiment; and

FIG. 35 shows the sixteenth embodiment of this invention.

### DESCRIPTION OF EMBODIMENTS

Preferred embodiments of the invention will be described by way of illustrative example, without limiting the scope of the invention. In the description of the second to sixteenth embodiments, the description of features that are common to a previous embodiment will not be repeated in detail.

### First Embodiment

This embodiment describes the basic concept whereby a voltage-dependent select capacitor is used to increase the sensitivity of the output of an active pixel sensor circuit to changes in the liquid crystal capacitance.

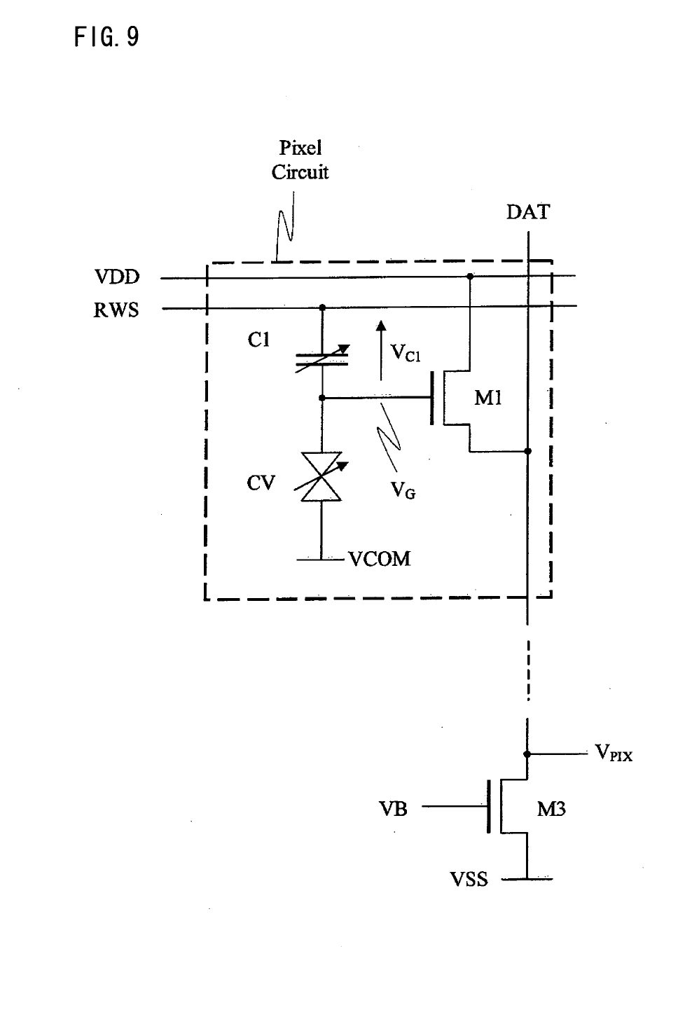

This embodiment relates to a liquid crystal device comprising an array of sensor circuits. In this embodiment each sensor circuit is an active pixel sensor circuit. As shown in FIG. 9, the active pixel sensor circuit forming a sensor circuit of this embodiment comprises a data line, DAT; a power supply line, VDD; a row select line, RWS; an amplifier, M1; a variable liquid crystal capacitor element, CV which functions in use as a liquid crystal sensing capacitor; and a voltage dependent select capacitor, C1. An input of the amplifier is connected to a terminal of the sensing capacitor.

Another terminal of the sensing capacitor of each sensor circuit may be connected to common voltage line VCOM such that the another terminal of the sensing capacitors of the sensor circuits are connected together.

In this embodiment the amplifier M1 comprises a transistor. The transistor forming the amplifier M1 may comprise a metal oxide semiconductor field effect transistor (MOSFET), such as a thin-film transistor. In this embodiment the transistor forming the amplifier M1 is connected as a source follower.

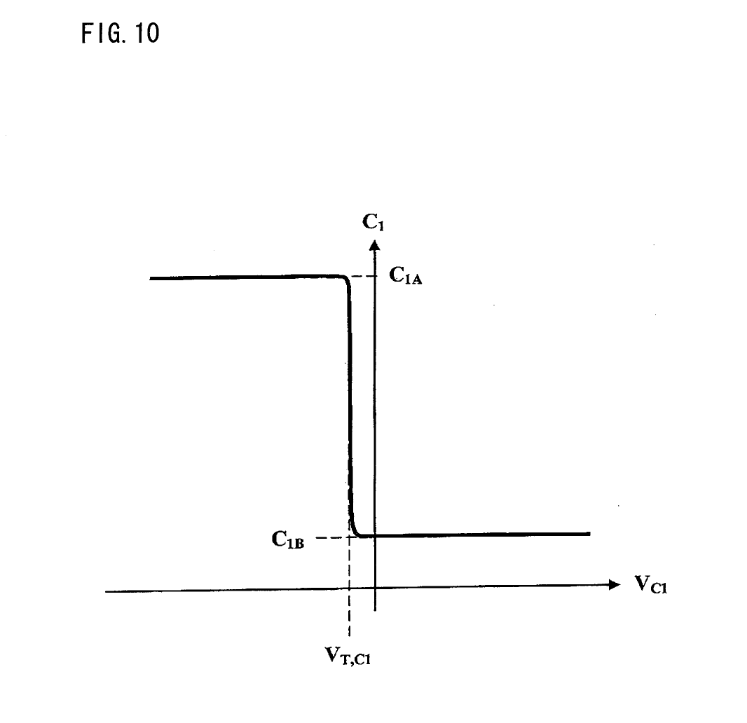

The voltage-dependent select capacitor, C1, has a capacitance, C1, which is related to the voltage across the capacitor, V_{C1}, and is characterized by a threshold voltage, V_{T,C1}, below which the capacitor exhibits a first capacitance, C_{1A} and above which the capacitor exhibits a second capacitance, C_{1B}. The capacitor may be arranged such that the first capacitance is significantly larger than the second capacitance. FIG. 10 illustrates such a voltage-capacitance relationship.

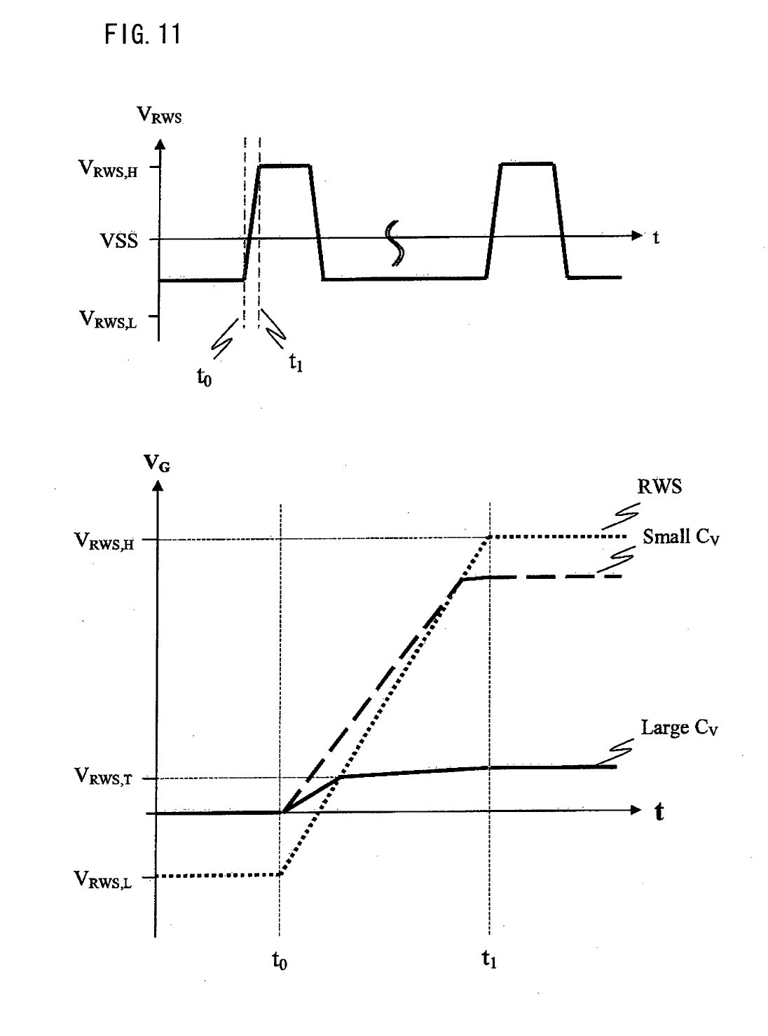

The operation of the active pixel sensor circuit is now described with reference to the waveform diagram of FIG. 11.

In a first initial period, the row select line RWS is at a first low potential V_{RWS,L} and the voltage of the gate terminal of the amplifier transistor M1, V_{G}, is equal to an initial voltage, V_{G0}, which is less than the threshold voltage of M1, V_{T,M1}. During this initial period the amplifier transistor M1 is therefore turned off so that the sensor circuit is inhibited. The low potential of RWS, V_{RWS,L} is arranged to be less than the gate voltage of the amplifier transistor, V_{G0}, such that the potential difference across the voltage dependent select capacitor, V_{C1}, is less than a threshold voltage of the capacitor, V_{T,C1}, and the capacitor exhibits a large first capacitance, C_{1A}.

In a second read-out period, the voltage of the row select line rises towards its final high potential V_{RWS,H}. At first, as the voltage of the row select line RWS begins to rise, charge is injected onto the gate terminal of the amplifier transistor M1 across the select capacitor C1. The voltage of the gate terminal as the row select line begins to rise is thus given by:

$$\begin{matrix}{V}_{G} = {V}_{G 0} + ( {V}_{RWS} - {V}_{RWS , L} ) \cdot {C}_{1 A} / ( {A}_{1 A} + {C}_{V} + {C}_{G , M 1} ) \\ = {V}_{G 0} + ( {V}_{RWS} - {V}_{RWS , L} ) \cdot {S}_{0}\end{matrix}$$

where: C_{V} is the capacitance of the variable liquid crystal capacitor CV; C_{G,M1} is the capacitance of the gate terminal of the amplifier transistor M1; and S₀ is the initial rate of increase of V_{G}.

The voltage of the gate terminal of the amplifier transistor therefore rises at a rate slower than that of the row select line RWS and inversely proportional to the capacitance of the variable liquid crystal capacitor element CV. At some point during the rise time of RWS, V_{RWS} may increase sufficiently relative to V_{G} that the potential difference across the voltage dependent select capacitor, V_{C1}, becomes greater than the threshold voltage of the select capacitor, V_{T,C1}. The select capacitor therefore exhibits a small second capacitance, C_{1B}, and the rate of increase in the voltage of the gate terminal as the row select line continues to rise is reduced. The voltage of the gate terminal is now given by:

$$\begin{matrix}{V}_{G} = {V}_{G 0} + ( {V}_{RWS , T} - {V}_{RWS , L} ) \cdot {S}_{0} + ( {V}_{RWS} - {V}_{RWS , T} ) \cdot \\ {C}_{1 B} / ( {C}_{1 B} + {C}_{V} + {C}_{G , M 1} ) \\ = {V}_{G 0} + ( {V}_{RWS , T} - {V}_{RWS , L} ) \cdot {S}_{0} + ( {V}_{RWS} - {V}_{RWS , T} ) \cdot {S}_{1}\end{matrix}$$

where: V_{RWS,T} is the voltage of the row select line corresponding to the transition of the select capacitor from high to low capacitance; and S₁ is the final rate of increase of V_{G}.

The final voltage of the gate terminal in the read-out period is achieved after the row select line has reached its high potential, V_{RWS,H}, and is given by

V_{G}=V_{G0}+(V_{RWS,T}−V_{RWS,L})·S₀+(V_{RWS,H}−V_{RWS,T})·S₁

During the read-out period, if the voltage of the gate terminal of the amplifier transistor M1 rises above its threshold voltage, V_{T,M1}, the transistor will switch on and form a source follower amplifier with the bias transistor M3 connected to the data line. The pixel output voltage, V_{PIX}, is defined as the output voltage of this source follower amplifier and is determined by the voltage of the gate terminal, V_{G}, and hence the capacitance of the liquid crystal capacitor element.

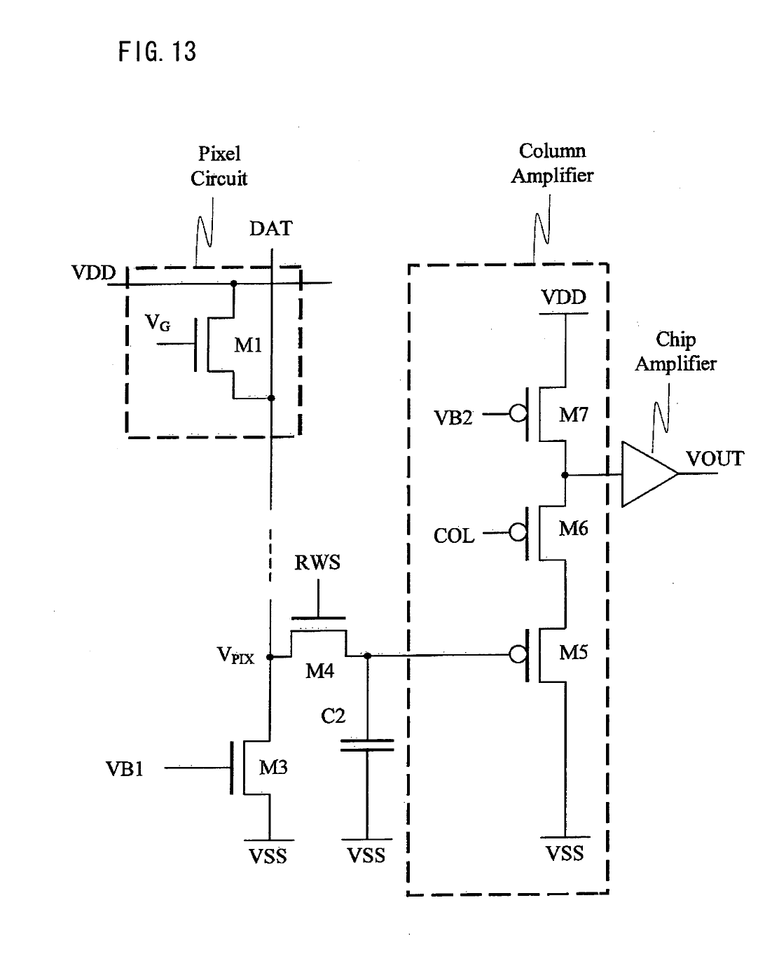

The output voltage generated by the source follower amplifier during the read-out period may be held on a storage capacitor and be subsequently read-out in a known manner, such as by the circuit shown in FIG. 13. The operation of this read-out circuit is briefly described:

When the row select line, RWS, is pulsed high during the read-out period the source follower output voltage is indicative of the capacitance of the variable liquid crystal capacitor element, CV. During this period, the storage capacitor, C2, is charged to the level of the source follower output via a select transistor M4. A second, column source follower amplifier is now formed by transistors M5, M6 and M7 and, when the column select signal, COL, is pulsed, the output of the column source amplifier is connected to a chip amplifier. Each column source amplifier is connected to the chip amplifier in this manner in turn such that the sensor output voltage is a time sequential representation of the capacitance of the variable liquid crystal capacitor within each pixel in the array.

The read-out circuits described above—including the use of a bias transistor, M3, connected to the data line to form a source follower amplifier with the pixel amplifier transistor, M1—are intended to be exemplary. Other suitable circuit techniques to generate and read-out the pixel data are well-known and may be used instead.

The active pixel sensor circuit of this embodiment as described above provides an amplification effect which arises from the voltage dependency of the select capacitor C1. The origin of the effect is that the row select voltage corresponding to the state transition of the select capacitor, V_{RWS,T}, is determined by the capacitance of the variable liquid crystal capacitor CV. As shown in FIG. 11, as C_{V} is increased the transition of the select capacitor to a low capacitance occurs for a smaller rise in the row select voltage.

In comparison to the prior art where a standard non-voltage dependent select capacitor is used, for a given change in liquid crystal capacitance, there is a larger change in the voltage of the gate terminal in the read-out period and hence a larger change in the pixel output voltage. An advantage of this embodiment is therefore an increase in the sensitivity of the sensor.

### Second Embodiment

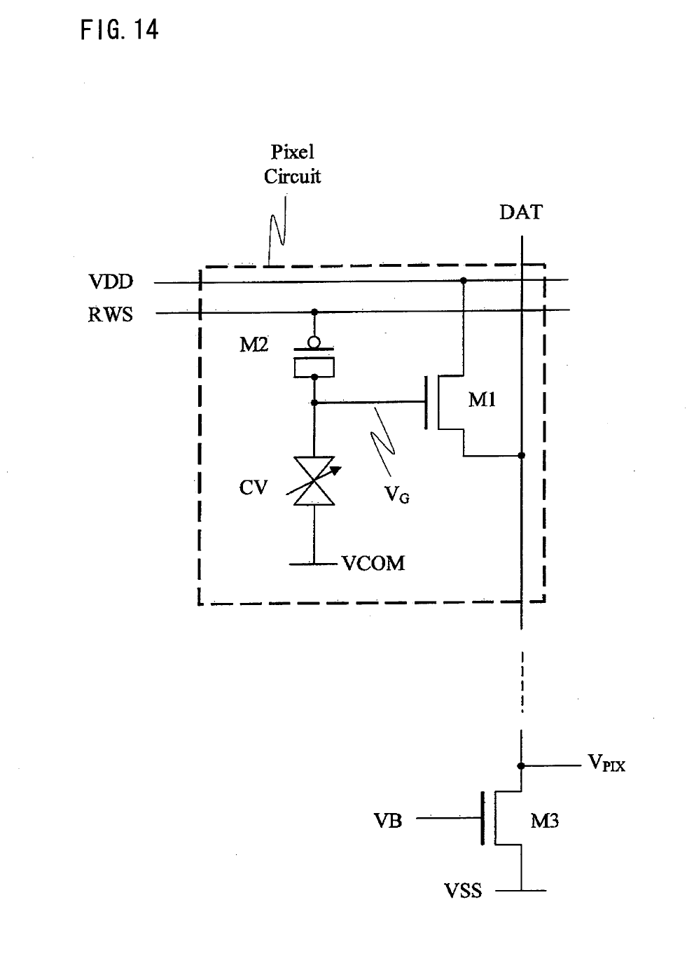

In the second embodiment of this invention, the select capacitor of the first embodiment may be formed by a metal-oxide-semiconductor field effect transistor (MOSFET), such as a thin-film transistor (TFT). The transistor may be a p-type transistor with the gate terminal connected to the row select line RWS and the source and drain terminal connected together to the gate terminal of the amplifier transistor. This arrangement is shown in FIG. 14 where the transistor M2 forms the voltage-dependent select capacitor.

In a first state, where the voltage between the gate and source terminals of the transistor M2, V_{GS}, is less than the threshold voltage of the transistor, V_{T,M2}, the transistor is turned on and exhibits a capacitance, C_{1A}, equal to the sum of the gate-drain, gate-source and gate-channel capacitances (C_{GD,M2}, C_{GS,M2} and C_{GC,M2} respectively). In a second state, where the voltage between the gate and source terminals of the transistor M2, V_{GS}, is greater than the threshold voltage of the transistor, V_{T,M2}, the transistor is turned off and exhibits a capacitance, C_{1B}, equal to the sum of the gate-drain and gate-source capacitances (C_{GD,M2} and C_{GS,M2}). The transistor M2 therefore exhibits the required voltage-capacitance relationship shown in FIG. 10.

The operation of this circuit is as described previously for the first embodiment.

### Third Embodiment

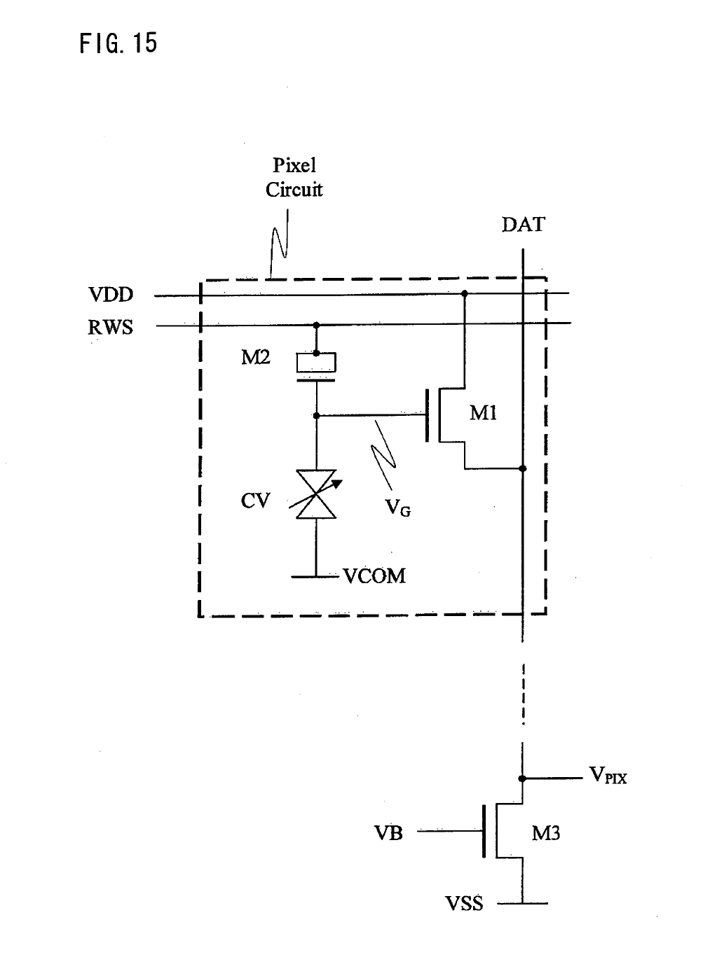

In the third embodiment of this invention, the select capacitor of the first embodiment may be formed by an n-type transistor. In this circuit, shown in FIG. 15, the gate terminal of the transistor M2 forming the select capacitor is connected to the gate terminal of the amplifier transistor M1 and the source and drain terminals of M2 connected together to the row select line RWS. Again, the transistor exhibits the required voltage-capacitance relationship shown in FIG. 10.

The operation of this circuit is as described previously for the first and second embodiments.

### Fourth Embodiment

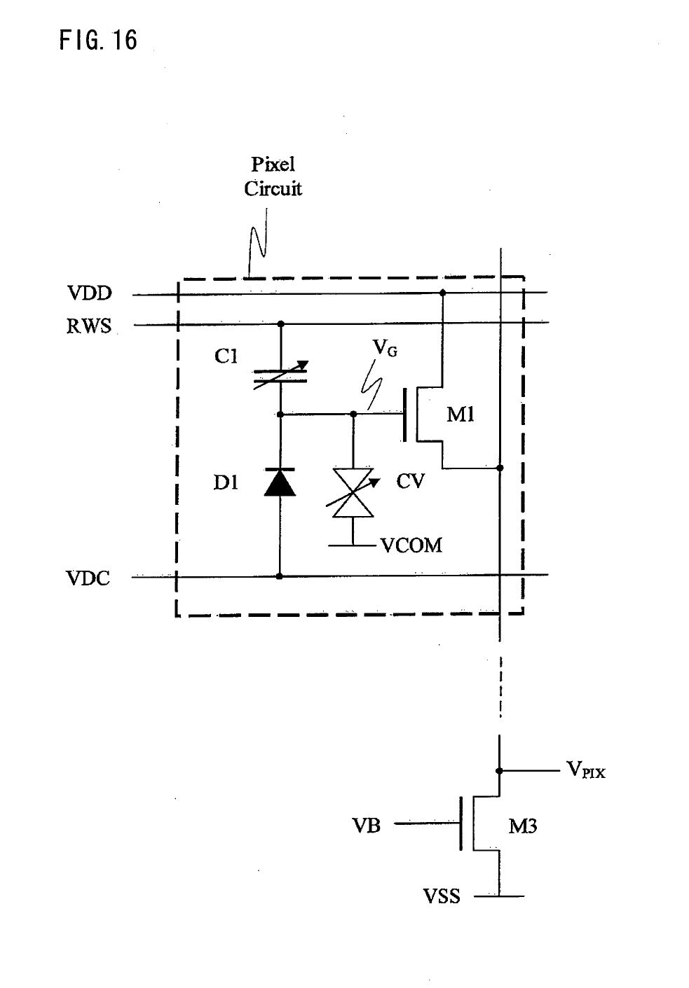

In the fourth embodiment of this invention, the DC voltage of the gate terminal may be fixed through the addition of a diode to the active pixel sensor circuit. As shown in FIG. 16, the cathode terminal of the diode is connected to the gate terminal of the amplifier transistor and the anode terminal to an additional addressing line VDC.

The diode provides a path between the gate terminal of the amplifier transistor and the address line VDC such that the initial, steady-state DC voltage of the gate terminal of the amplifier transistor, V_{G0}, is determined by the constant voltage applied to the address line VDC, V_{DC}.

When the row select line RWS is made high, the voltage of the gate terminal of the amplifier transistor is increased by charge injection across the select capacitor and becomes greater than the constant voltage of the address line VDC, V_{G}>V_{DC}. Since the diode D1 is now reverse biased and presents a high resistance, the relatively high-speed read-out operation is unaffected by the presence of the diode and proceeds as described previously.

An advantage of this embodiment is that the initial voltage of the gate terminal of the amplifier transistor, V_{G0}, can be set to a known value. Without this facility, charge generated during the manufacturing process may become trapped on this node resulting in an unknown initial voltage which may cause a malfunction of the sensor operation. The diode provides a path for this trapped charge to discharge ensuring the correct and reliable operation of the sensor.

The use of a diode in this way is intended to illustrate the concept of fixing the steady-state DC voltage of the gate terminal of the amplifier transistor without interfering with the high-speed read-out operation. The same function may be achieved through other well-known means such as a transistor connected in a diode configuration or a resistor of sufficiently high resistance.

### Fifth Embodiment

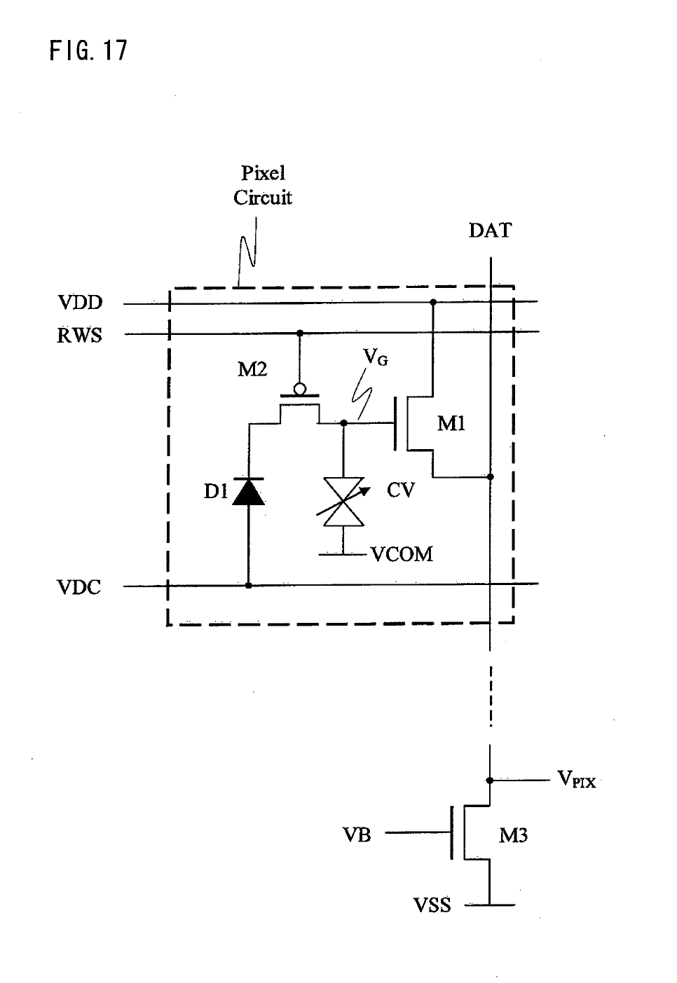

In the fifth embodiment of this invention, the voltage-dependent select capacitor of the fourth embodiment comprises a p-type transistor. As shown in FIG. 17, the p-type transistor, M2, is arranged with its gate terminal connected to the row select line, RWS, its drain terminal connected to the gate terminal of the amplifier transistor M1 and its source terminal connected to the cathode terminal of a diode, D1.

As described in the fourth embodiment, the diode is used to fix the steady-state DC voltage of the gate terminal of the amplifier transistor. The purpose of the remaining elements and the operation of this active pixel sensor circuit is as described above for the second embodiment. As before, in a first state the transistor M2 exhibits a capacitance, C_{1A}, between the row select line, RWS, and the gate terminal of the amplifier transistor M1, V_{G}, which is equal to the sum of the gate-drain, gate-source and gate-channel capacitances (C_{GD,M2}, C_{GS,M2} and C_{GC,M2} respectively). However, in a second state when the voltage between the gate and source terminals of M2, V_{GS}, is greater than the threshold voltage of the transistor, V_{T,M2}, and the transistor is turned off, M2 exhibits a capacitance, C_{1B}, which is now equal to only the gate drain capacitance, C_{GD,M2}.

As a result of the reduced capacitance in the second state, the final rate of increase of V_{G}, S₁, is reduced and the amplification effect of the transistor M2—which is proportional to the ratio S₀/S₁—is increased. An advantage of this embodiment is therefore an increase in the sensitivity of the active pixel sensor circuit.

### Sixth Embodiment

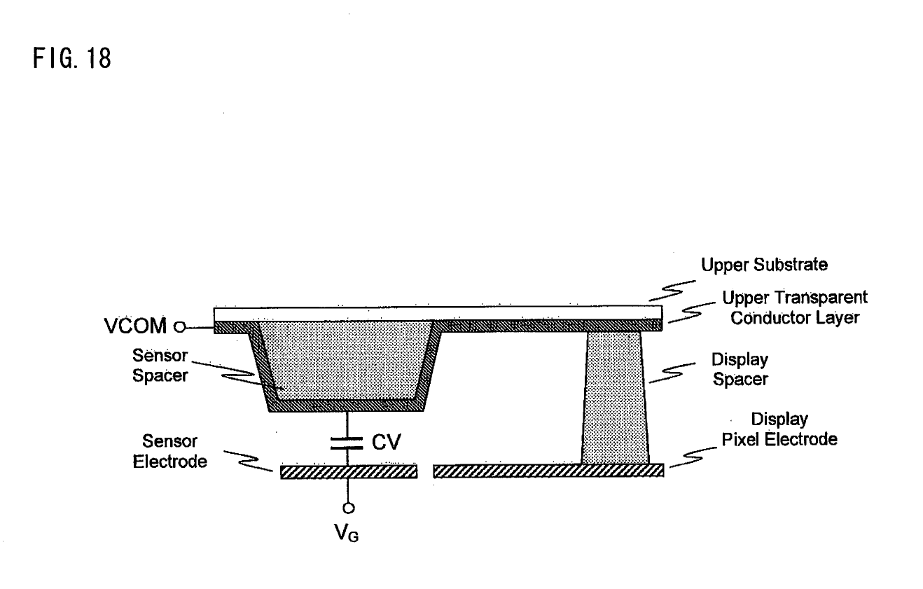

In the sixth embodiment of this invention, the cell-gap in the region of the variable liquid crystal capacitor, CV, of any of the preceding embodiments is made narrow through the use of a protrusion beneath the transparent conductor layer on one or both of the opposing substrates. This arrangement is shown in the cross-section of FIG. 18. The structure and use of such a protrusion is well-known—as disclosed, for example, in “Embedded Liquid Crystal Capacitive Touch Screen Technology for Large Size LCD Applications” described previously—and is not described further in this disclosure.

An advantage of this embodiment is that, for a given mechanical deformation of the cell-gap, the relative change in the capacitance of the liquid crystal capacitor element is increased. The pixel circuit is therefore more sensitive to the touch input force as it produces a larger output voltage swing for a given change in pressure input.

### Seventh Embodiment

This embodiment describes the basic concept whereby a pre-charge operation is used to increase the sensitivity of the output of an active pixel sensor circuit to changes in the liquid crystal capacitance.

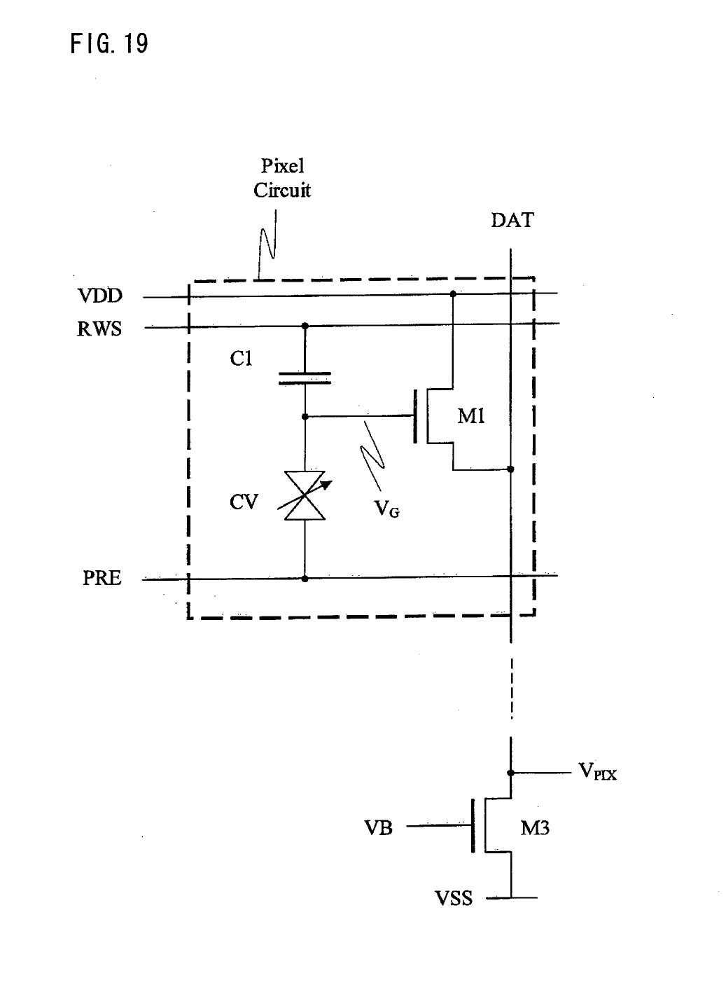

This embodiment relates to a liquid crystal device comprising a first array of first sensor circuits. In this embodiment each first sensor circuit is an active pixel sensor circuit. As shown in FIG. 19, each active pixel sensor circuit of this embodiment comprises: a data line, DAT; a power supply line, VDD; a row select line, RWS; a pre-charge line, PRE; an amplifier M1; a variable liquid crystal capacitor element, CV which functions in use as a liquid crystal sensing capacitor; and a select capacitor, C1.

In this embodiment the amplifier M1 comprises a first transistor. The first transistor forming the amplifier M1 may be formed as a first metal oxide semiconductor field effect transistor (MOSFET), such as a thin-film transistor. In this embodiment the first transistor forming the amplifier M1 is connected as a source follower.

The variable liquid crystal capacitor is connected between the gate terminal of the amplifier transistor M1 and the pre-charge line, PRE.

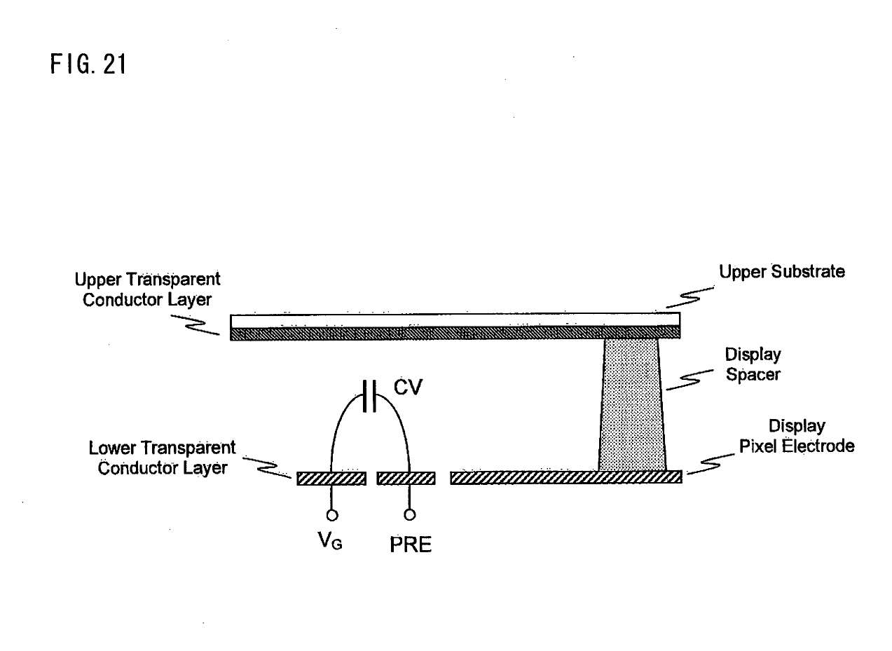

The variable liquid crystal capacitor may be formed by a planar structure, for example as shown in FIG. 21, in which the electrodes of the capacitor are formed by the same transparent conducting layer so that the electrodes of the capacitor are coplanar electrodes. The transparent conducting layer in which the capacitor electrodes are patterned may be formed on the same substrate as the amplifier transistor M1, select capacitor C1 and address lines VDD, RWS and PRE. The transparent conducting layer on the opposing substrate may be common and continuous across the whole sensor array.

The select capacitor C1 is connected between the gate terminal of the amplifier transistor M1 and the row select line, RWS.

The pre-charge line, PRE is connected to a sensor circuit pre-charge input (not shown) that may received a voltage that it is desired to apply to the pre-charge line, PRE. Similarly, the row select line, RWS is connected to a sensor circuit selecting input (not shown) that may received a voltage that it is desired to apply to the pre-charge line, PRE.

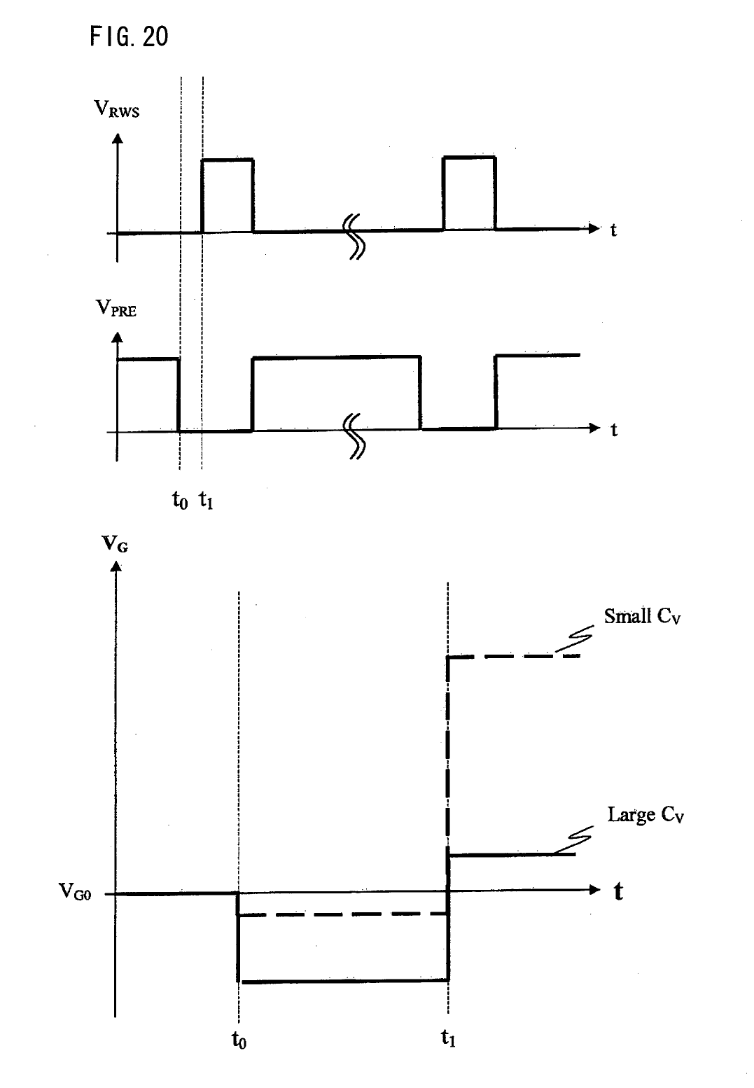

The operation of the active pixel sensor circuit is now described with reference to the waveform diagram FIG. 20.

In a first, precharge period, the precharge input receives a first voltage and so the pre-charge line PRE is at a first high potential, V_{PRE,H}, the selecting input receives a third voltage so that the row select line RWS is at a first low potential V_{RWS},L and the voltage of the gate terminal of the amplifier transistor M1, V_{G}, is equal to an initial voltage, V_{G0}, which is less than its threshold voltage, V_{T,M1}. During this period the amplifier transistor M1 is therefore turned off.

In a second, pre-charge period, the precharge input receives a second voltage whose value is less than that of the first voltage so that the pre-charge line PRE is brought to a second low potential, V_{PRE,L}. This fall in the voltage of the pre-charge line causes charge to be removed from the gate terminal of the amplifier transistor in an amount determined by the capacitance of the liquid crystal capacitor, CV, connected between the gate terminal and the pre-charge line. The voltage of the gate terminal of the amplifier transistor, V_{G}, in this period is given by the equation:

V_{G}=V_{G0}−(V_{PRE,H}−V_{PRE,L})·C_{V}/(C₁+C_{V}+C_{G,M1})

where: C_{V} is the capacitance of the variable liquid crystal capacitor CV; C₁ is the capacitance of the select capacitor C1; and C_{G,M1} is the capacitance of the gate terminal of the amplifier transistor M1.

In a third, read-out period, the selecting input receives a fourth voltage whose value is greater than that of the third voltage so that the row select line is brought to a second high potential, V_{RWS,H}, and charge is injected onto the gate terminal of the amplifier transistor M1 via the select capacitor C1. The rise in voltage of the gate terminal is determined by the capacitance of the variable liquid crystal capacitor and V_{G} is given by the equation:

V_{G}=V_{G0}+[(V_{RWS,H}−V_{RWS,L})·C₁−(V_{PRE,H}−V_{PRE,L})·C_{V}]/(C₁+C_{V}+C_{G,M1})

During the read-out period, if the voltage of the gate terminal of the amplifier transistor M1 rises above its threshold voltage, V_{T,M1}, the transistor will switch on and form a source follower amplifier with the bias transistor M3 connected to the data line. The pixel output voltage, V_{PIX}, is defined as the output voltage of this source follower amplifier and is determined by the voltage of the gate terminal, V_{G}, and hence the capacitance of the liquid crystal capacitor element.

At the end of the read-out period, the pre-charge line PRE is returned to a first high potential, V_{PRE,H}, and the row select line is returned to a first low potential, V_{RWS,L}. The gate terminal of the amplifier transistor therefore returns to its initial potential, V_{G0}, and the amplifier transistor is turned off.

The output voltage generated by the source follower amplifier during the read-out period may be held and read-out in a known manner, such as described previously.

An advantage of this embodiment over the prior art is that the sensitivity of the pixel output signal to changes in liquid crystal capacitance is increased.

The sensitivity of the active pixel circuit as described above to changes in the capacitance of the variable liquid crystal capacitor is derived both from the pre-charge operation and the read-out operation. The pre-charge operation generates a reduction in the gate voltage of the amplifier transistor M1, V_{G}, which is proportional to the liquid crystal capacitance, C_{V}, whilst the read-out operation generates an increase in V_{G} which is inversely proportional to C_{V}. The additive effect of these two operations gives an advantage over the prior art as the sensitivity of the pixel output signal to changes in liquid crystal capacitance is increased.

### Eighth Embodiment

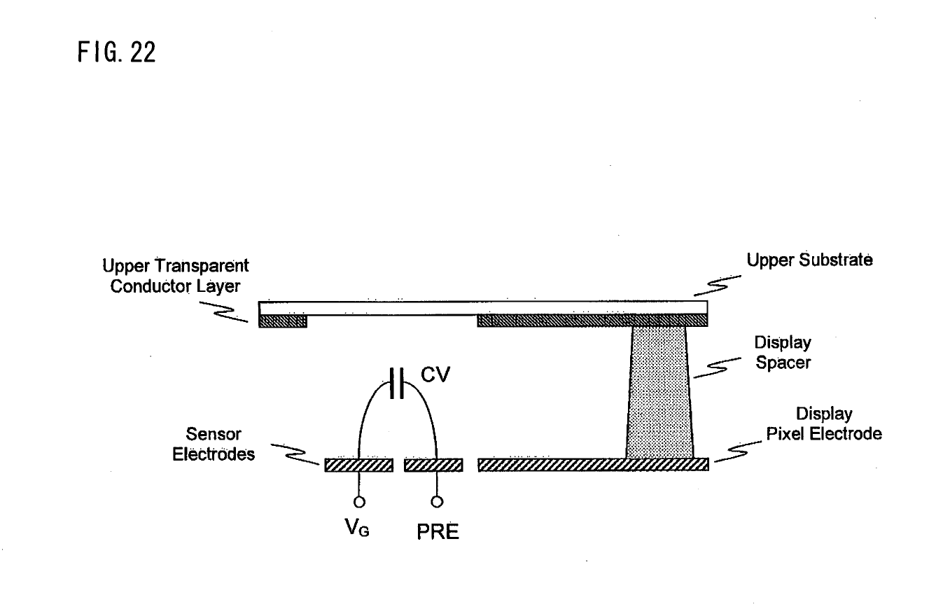

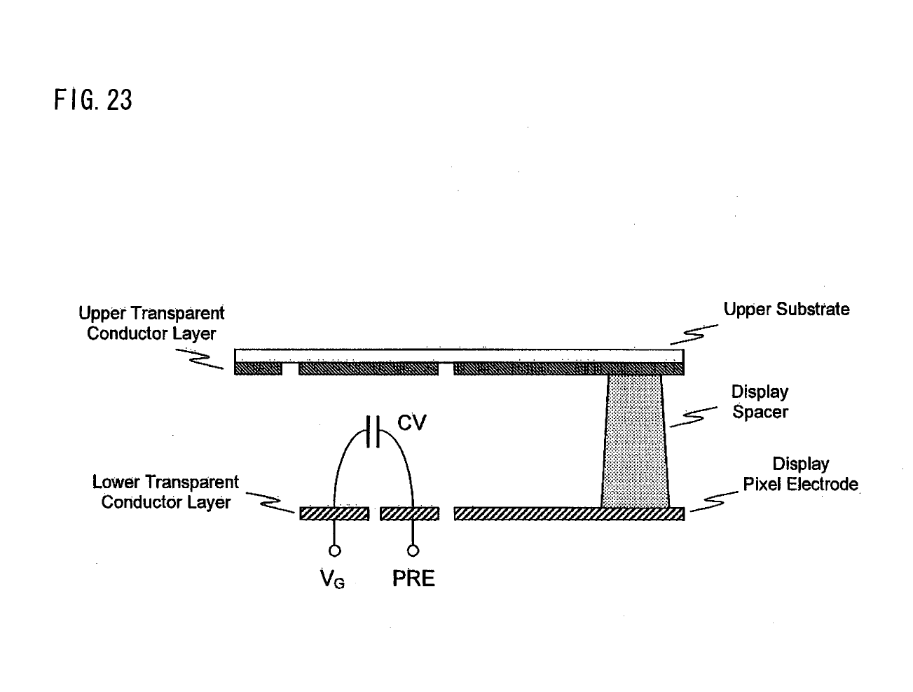

In the eighth embodiment of this invention, the common transparent conducting electrode of the seventh embodiment is patterned in the region opposite the planar electrodes of the variable liquid crystal capacitor, CV, formed by the transparent conductor of the opposing substrate. Patterning of this counter electrode may be used to create a hole in the common electrode, as shown in FIG. 22, or an electrically floating electrode segment, as shown in FIG. 23.

An advantage of this embodiment is that the parasitic capacitance from the display common electrode to the sensor electrodes on the opposing substrate is reduced and the interference from the display operation to the active pixel sensor circuit is consequently reduced.

### Ninth Embodiment

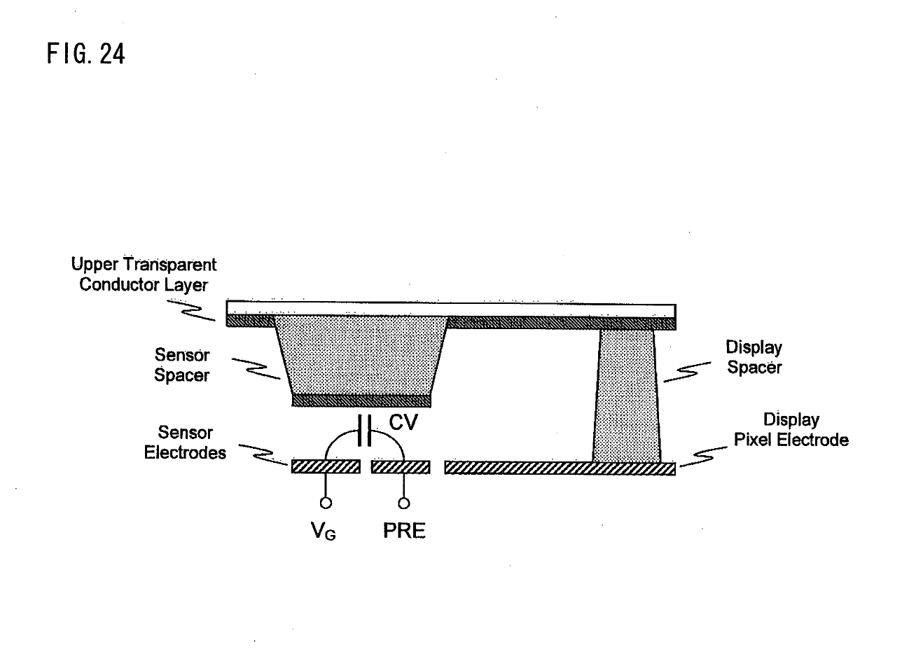

In the ninth embodiment of this invention, the cell-gap in the region of the variable liquid crystal capacitor, CV, of the seventh or eighth embodiments is made narrow through the use of a protrusion beneath the transparent conductor layer on one or both of the opposing substrates, as shown in the cross-section of FIG. 24. As stated above, the structure and use of such a protrusion is well-known and is not described further in this disclosure.

An advantage of this embodiment is that, for a given mechanical deformation of the cell-gap, the relative change in the capacitance of the liquid crystal capacitor element is increased. The pixel circuit is therefore more sensitive to the touch input force as it produces a larger output voltage swing for a given change in pressure input.

### Tenth Embodiment

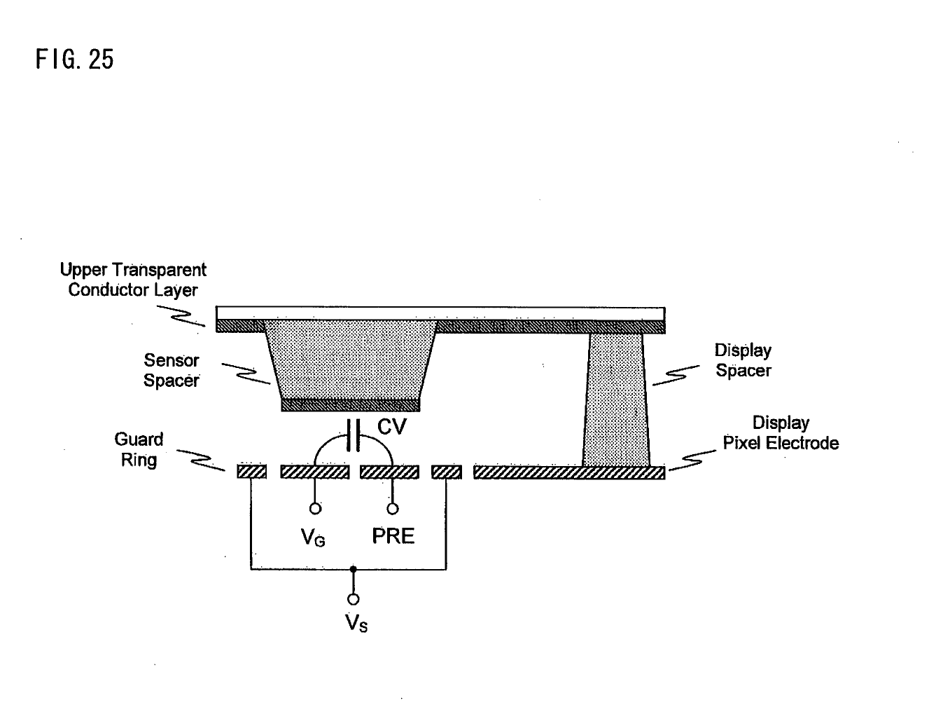

In the tenth embodiment of this invention, the transparent conducting layer forming the sensor electrode(s) of any of the previous embodiments is further patterned to create a guard ring. As shown in FIG. 25, the guard ring extends around sensor electrode(s) and provides electrical isolation between the sensor electrode(s) and the display pixel electrode. The guard ring may be driven to a defined electrical potential, V_{S}, such as the ground potential. The guard ring is co-planar with the sensor electrode(s).

A disadvantage of the previous embodiments is that parasitic capacitive coupling between the sensor electrodes and the display pixel electrode may lead to interference in the operation of the sensor. Not only does the voltage of the display pixel electrode directly couple to the sensor pixel electrodes, but the liquid crystal material itself is disturbed in the area around the display pixel electrode according to this voltage. As a result, the state of the liquid crystal material in the region of the sensor electrodes, and hence the capacitance of the variable liquid crystal capacitor element being measured, is affected by the display data. An advantage of this embodiment is that the guard ring electrically isolates the sensor and display electrodes and controls the state of the liquid crystal material in the region around the sensor electrodes. Interference between the sensor and display operations is therefore reduced.

### Eleventh Embodiment

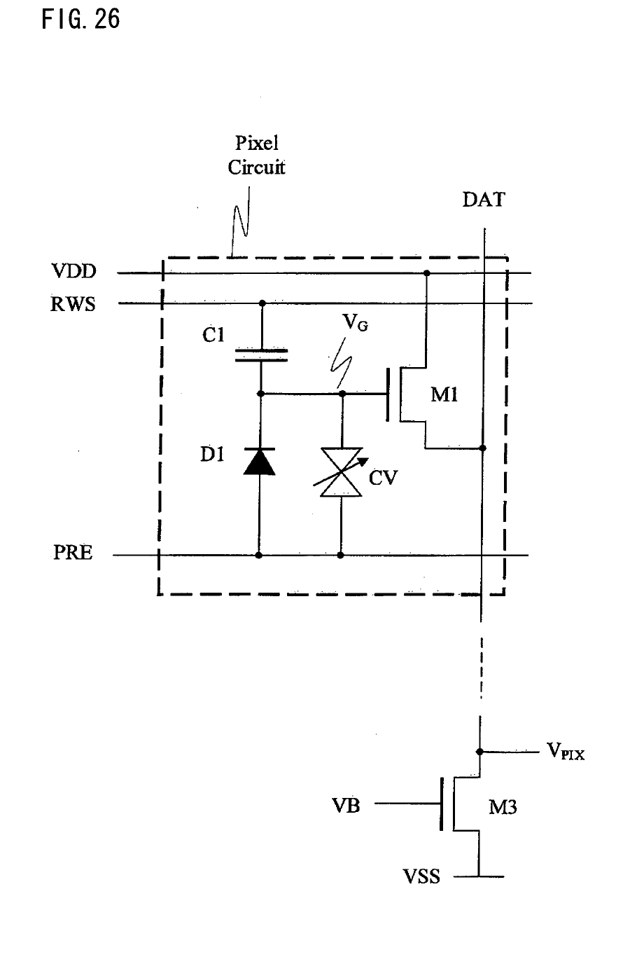

In the eleventh embodiment of this invention, the DC voltage of the gate terminal of the amplifier transistor of any of the seventh to tenth embodiments may be fixed through the addition of a diode to the active pixel sensor circuit. As shown in FIG. 26, the cathode terminal of the diode is connected to the gate terminal of the amplifier transistor and the anode terminal to an additional addressing line VDC.

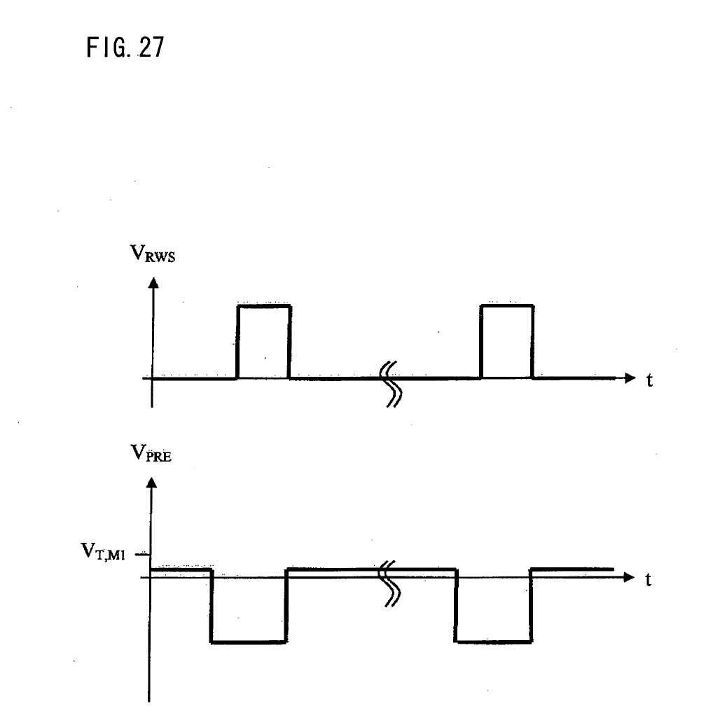

The operation of this circuit is similar to that described in the fourth embodiment. The diode provides a path between the gate terminal of the amplifier transistor and the address line PRE such that the initial, steady-state DC voltage of the gate terminal of the amplifier transistor, V_{G0}, is equal to the constant, predetermined voltage applied to the pre-charge line PRE, V_{PRE}. As illustrated in the waveform diagram of FIG. 27 since the pre-charge line is active low and hence normally in the high state, the high potential of the pre-charge signal must be chosen to be less than the threshold voltage of the amplifier transistor M1, V_{T,M1}, such that M1 remains turned off outside of the read-out period.

An advantage of this embodiment is that the initial voltage of the gate terminal of the amplifier transistor, V_{G0}, can be set to a known value and hence the reliability of the circuit may be improved.

### Twelfth Embodiment

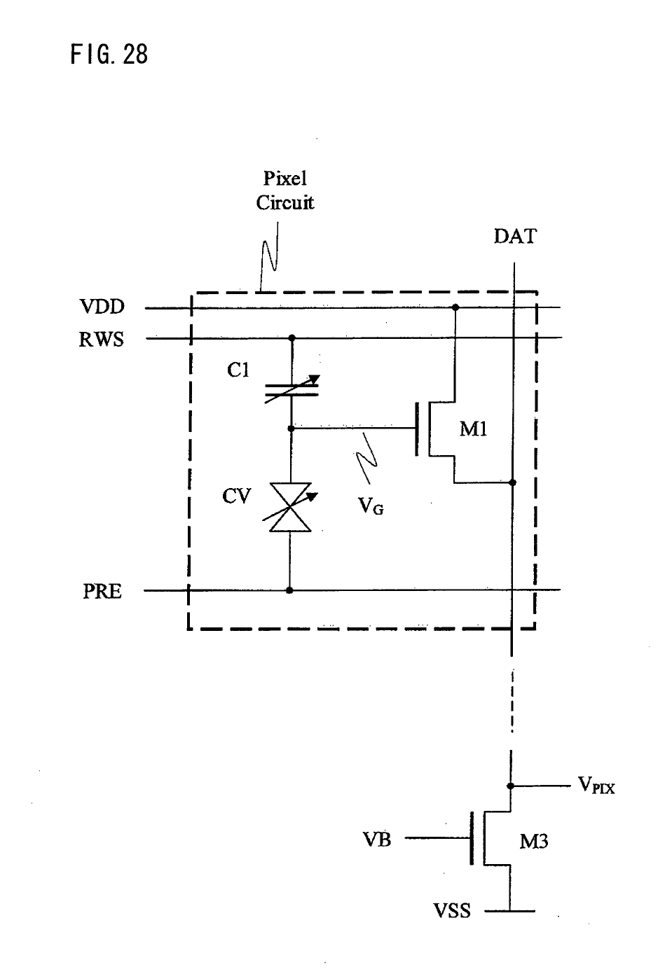

The select capacitor may be a voltage dependent select capacitor. In the twelfth embodiment of this invention, the variable liquid crystal capacitor, the pre-charge line and the voltage dependent select capacitor are combined within the same active pixel sensor circuit. An example of this combination is shown in FIG. 28 and comprises: a data line, DAT; a power supply line, VDD; a row select line, RWS; a pre-charge line, PRE; an amplifier transistor, M1; a variable liquid crystal capacitor element, CV; and a voltage dependent select capacitor, C1.

The variable liquid crystal capacitor is connected between the gate terminal of the amplifier transistor M1 and the pre-charge line, PRE. The variable liquid crystal capacitor element may be formed as described in any of the seventh to tenth embodiments. The voltage dependent select capacitor is connected between the gate terminal of the amplifier transistor M1 and the row select line, RWS. The voltage-dependent liquid crystal capacitor element may exhibit the voltage-capacitance relationship and be formed as described in the first, second or third embodiments. For example, the voltage dependent select capacitor may be formed as a second transistor, and for example may be formed as a second metal oxide semiconductor field effect transistor (MOSFET), such as a thin-film transistor.

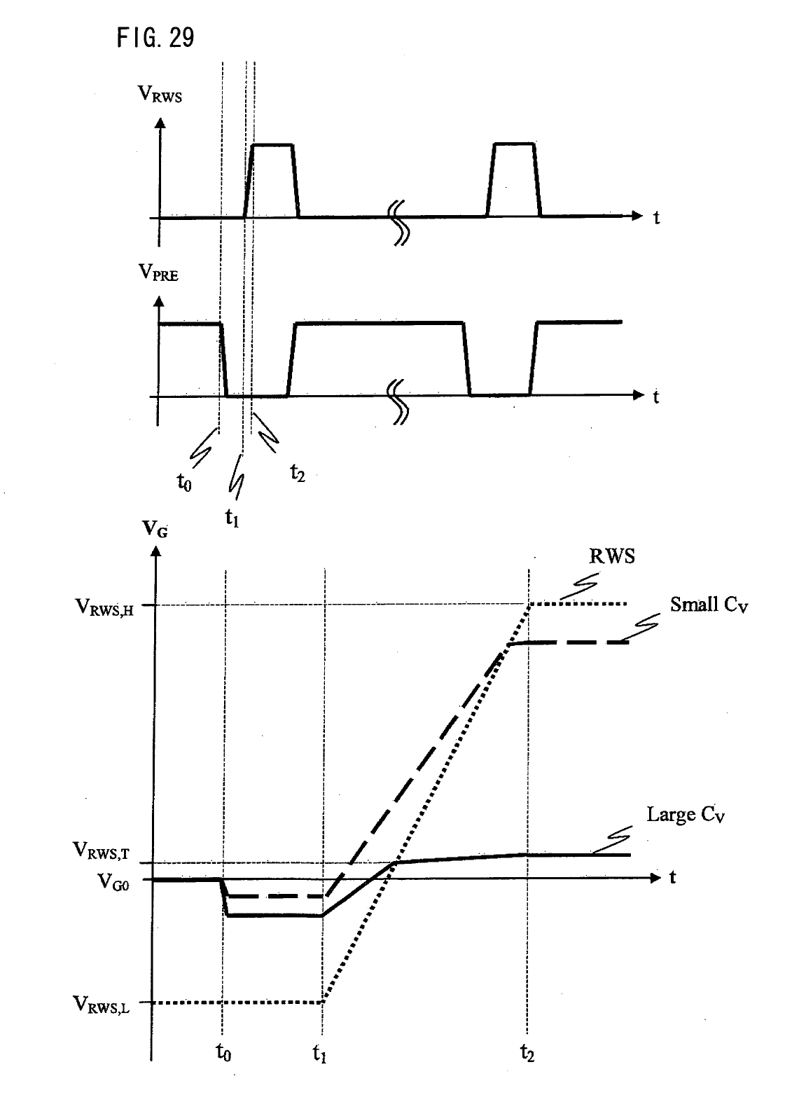

The operation of the active pixel sensor circuit is now described with reference to the waveform diagram of FIG. 29.

In a first, initial period, the pre-charge line PRE is at a first high potential, V_{PRE,H}, and the row select line RWS is at a first low potential, V_{RWS,L}. The voltage of the gate terminal of the amplifier transistor M1, V_{G}, is equal to an initial voltage, V_{G0}, which is less than its threshold voltage, V_{T,M1}, and relative to V_{RWS,L} less than a threshold voltage of the select capacitor, V_{T,C1}. During this period the amplifier transistor M1 is therefore turned off and the select capacitor exhibits a large first capacitance, C_{1A}.

In a second, pre-charge period, the pre-charge line is brought to a second low potential, V_{PRE,L}. This fall in the voltage of the pre-charge line causes charge to be removed from the gate terminal of the amplifier transistor in an amount determined by the capacitance of the liquid crystal capacitor, CV, connected between the gate terminal and the pre-charge line. The voltage of the gate terminal of the amplifier transistor, V_{G}, in this period is given by the equation:

V_{G}=V_{G0}−(V_{PRE,H}−V_{PRE,L})·C_{V}/(C_{1A}+C_{V}+C_{G,M1})

where: C_{V} is the capacitance of the variable liquid crystal capacitor CV; C_{1A} is the capacitance of the select capacitor C1 in an initial first state; and C_{G,M1} is the capacitance of the gate terminal of the amplifier transistor M1.

The first low potential of the row select line, V_{RWS,L}, is arranged such that voltage across the select capacitor, V_{C1}, remains less than the threshold voltage of the select capacitor, V_{T,C1}, throughout the second, pre-charge period. The select capacitor in this period therefore continues to exhibit a large first capacitance, C_{1A}.

In a third read-out period, the voltage of the row select line starts to rises towards its final high potential V_{RWS,H}. At first, as the voltage of the row select line RWS begins to rise, charge is injected onto the gate terminal of the amplifier transistor M1 across the select capacitor C1. The voltage of the gate terminal as the row select line begins to rise is given by:

V_{G}=V_{G0}+[(V_{RWS}−V_{RWS,L})·C₀−(V_{PRE,H}−V_{PRE,L})·C_{V}]/(C_{1A}+C_{V}+C_{G,M1})

The voltage of the gate terminal of the amplifier transistor rises at a rate slower than that of the row select line RWS and determined by the voltage of the variable liquid crystal capacitor element CV. At some point during the rise time of RWS, V_{RWS} may increase sufficiently relative to V_{G} such that the potential difference across the voltage dependent select capacitor, V_{C1}, becomes greater than the threshold voltage of the select capacitor, V_{T,C1}. The select capacitor therefore exhibits a small second capacitance, C_{1B}, and the rate of increase in the voltage of the gate terminal as the row select line continues to rise is reduced. The voltage of the gate terminal is now given by:

$${V}_{G} = {V}_{G 0} + [ ( {V}_{RWS , T} - {V}_{RWS , L} ) \cdot {C}_{1 A} - ( {V}_{PRE , H} - {V}_{PRE , L} ) \cdot {C}_{V} ] / ( {C}_{1 A} + {C}_{V} + {C}_{G , M 1} ) + ( {V}_{RWS} - {V}_{RWS , T} ) \cdot {C}_{1 B} / ( {C}_{1 B} + {C}_{V} + {C}_{G , M 1} )$$

where: V_{RWS,T} is the voltage of the row select line corresponding to the transition of the select capacitor from high to low capacitance.

The final voltage of the gate terminal in the read-out period is achieved after the row select line has reached it high potential, V_{RWS,H}, and is given by:

$${V}_{G} = {V}_{G 0} + [ ( {V}_{RWS , T} - {V}_{RWS , L} ) \cdot {C}_{1 A} - ( {V}_{PRE , H} - {V}_{PRE , L} ) \cdot {C}_{V} ] / ( {C}_{1 A} + {C}_{V} + {C}_{G , M 1} ) + ( {V}_{RWS , H} - {V}_{RWS , T} ) \cdot {C}_{1 B} / ( {C}_{1 B} + {C}_{V} + {C}_{G , M 1} )$$

During the read-out period, if the voltage of the gate terminal of the amplifier transistor M1 rises above its threshold voltage, V_{T,M1}, the transistor will switch on and form a source follower amplifier with the bias transistor M3 connected to the data line. The pixel output voltage, V_{PIX}, is defined as the output voltage of this source follower amplifier and is determined by the voltage of the gate terminal, V_{G}, and hence the capacitance of the liquid crystal capacitor element.

At the end of the read-out period, the pre-charge line PRE is returned to a first high potential, V_{PRE,H}, and the row select line is returned to a first low potential, V_{RWS,L}. The gate terminal of the amplifier transistor therefore returns to its initial potential, V_{G0}, and the amplifier transistor is turned off.

The output voltage generated by the source follower amplifier during the read-out period may be held and read-out in a known manner, such as described previously.

The amplification effect of this active pixel sensor circuit arises from the voltage dependency of the select capacitor C1 and fact that the row select voltage corresponding to the transition of this select capacitor, V_{RWS,T}, is determined by the capacitance of the variable liquid crystal capacitor CV. As shown in FIG. 29, as C_{V} increases the transition of the select capacitor to a low capacitance occurs for a smaller rise in the row select voltage. The reduction in the voltage of the gate terminal of the amplifier transistor generated by the pre-charge operation generates a potential difference across the select capacitor, V_{C1}, which is determined by the capacitance of the variable liquid crystal capacitor. The increase in the voltage of the row select line required for V_{C1} to rise above the threshold voltage, V_{T,C1}, is therefore determined not only by the rate of increase of the gate terminal due to the rising edge of RWS, as described previously, but also by the value of V_{C1} at the end of the pre-charge period.

An advantage of this embodiment is therefore that the combination of pre-charge operation and voltage-dependent select capacitor allows the sensitivity of the sensor to be increased beyond what may be achieved by either of these aspects alone.

### Thirteenth Embodiment

This embodiment comprises the integration of both sensor elements and display elements within one AMLCD sub-pixel circuit wherein: the sensor elements may constitute an active pixel sensor circuit as described in any of the previous embodiments; and the display elements further comprise a pixel switch transistor, storage capacitor and liquid crystal element. The operation of these display elements is well-known and is not described further in this disclosure.

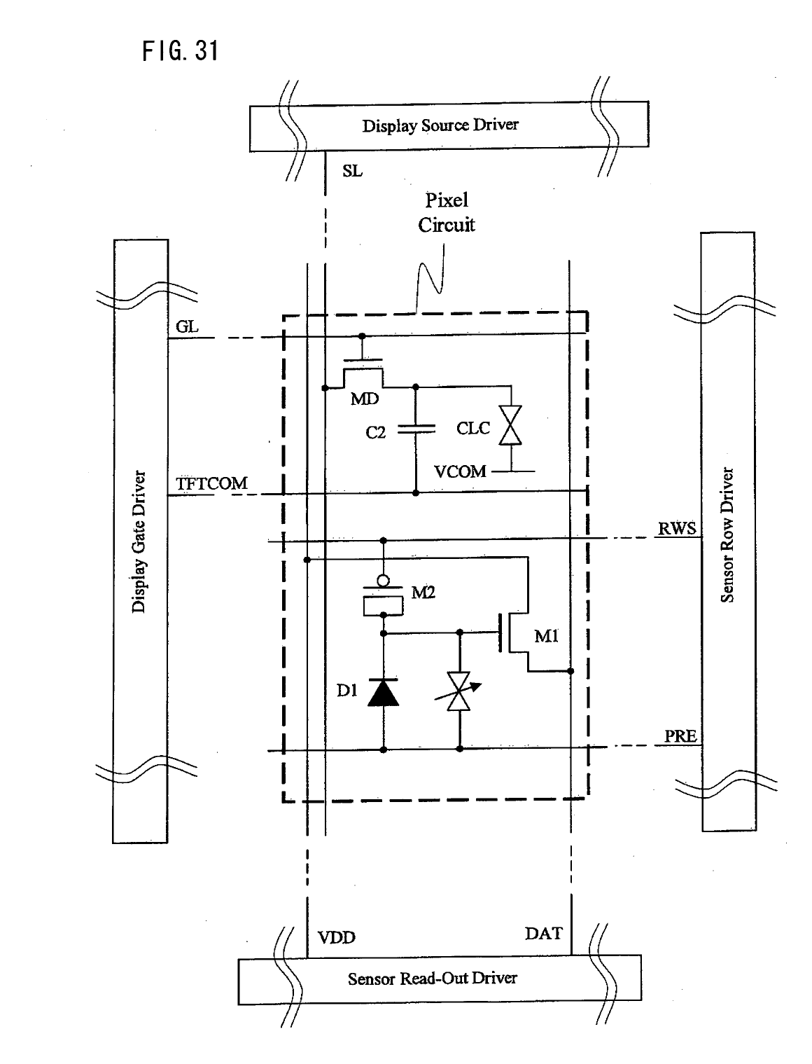

FIG. 31 shows an example configuration of this embodiment in which the pixel circuit of the twelfth embodiment is integrated together with display elements in the sub-pixel of an AMLCD. The sensor read-out driver includes the column bias transistor (which forms a source follower amplifier with the pixel source follower transistor) and additional circuits, for example as disclosed in the prior art, to output the sensor signal from the device.

### Fourteenth Embodiment

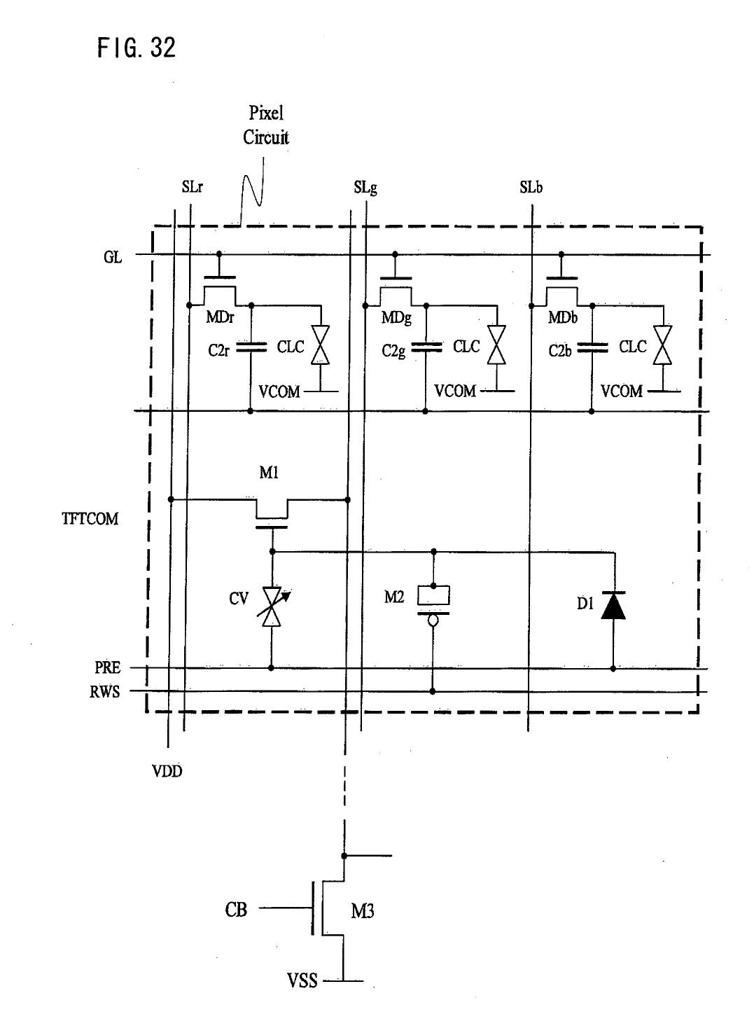

In the fourteenth embodiment of this invention, the active pixel sensor circuit of any of the first to twelfth embodiments is integrated within a plurality of pixels of an AMLCD arranged as a second array of liquid crystal display pixels. The first array of first sensor circuits and the second array of liquid crystal display pixels are addressed by a common active matrix addressing arrangement. The arrangement of FIG. 32 illustrates the concept of integrating the active pixel sensor circuit across one display pixel. The display pixel may comprise a composite colour group of sub-pixels for example it may comprises three sub-pixels which separately control the intensity of red, green and blue (RGB) wavelengths displayed by the pixel. The elements of the sensor pixel circuit may be arranged in any suitable manner across these three sub-pixels.

An advantage of this embodiment is that the aperture ratio of the display is increased compared to the previous embodiment. The circuit of FIG. 32 is intended to be exemplary and the elements of the sensor pixel circuit may be arranged across any multiple of display sub-pixels.

### Fifteenth Embodiment

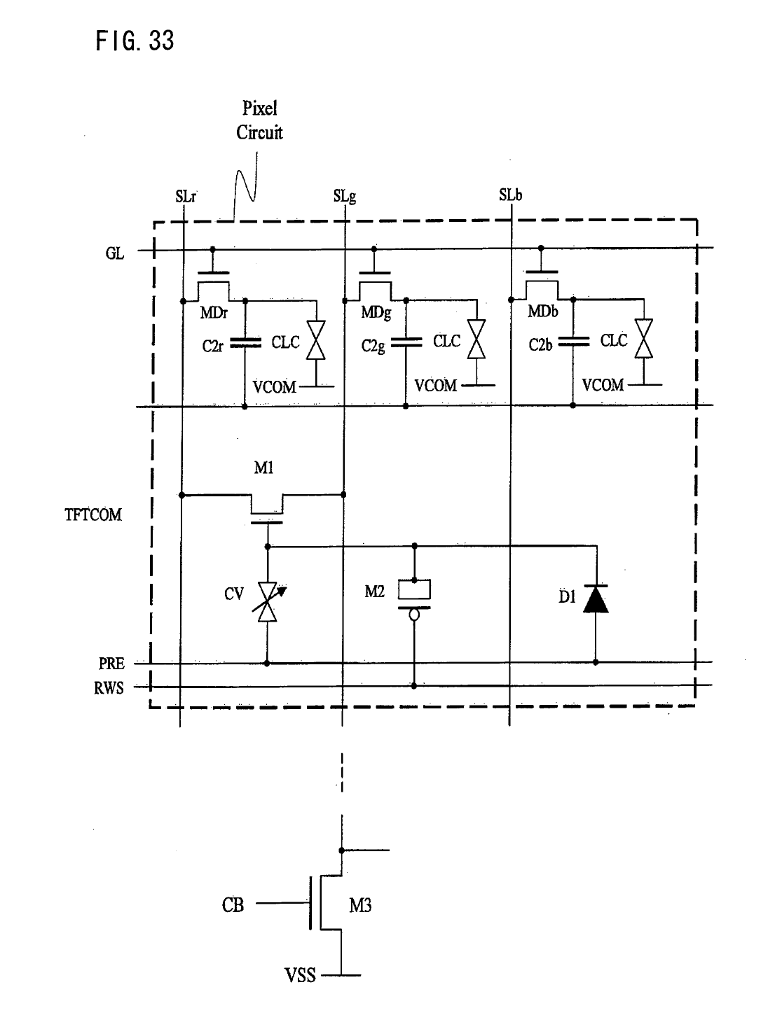

In the fifteenth embodiment of this invention, shown in FIG. 33, the active pixel sensor circuit of any of the first to twelfth embodiments is integrated within each pixel of an AMLCD whereby the sensor and display elements share common signal lines.

The display source lines may be used as the high power source and output lines of the sensor pixel source follower amplifier by time-sharing means. In order to read-out the pixel value, the sensor pixel source follower amplifier need only be formed for a small portion of the total sensor row time. This time can be arranged to be co-incident with the display horizontal blanking period in which the display source lines are normally disconnected. No significant change therefore needs to be made to the display driver circuits.

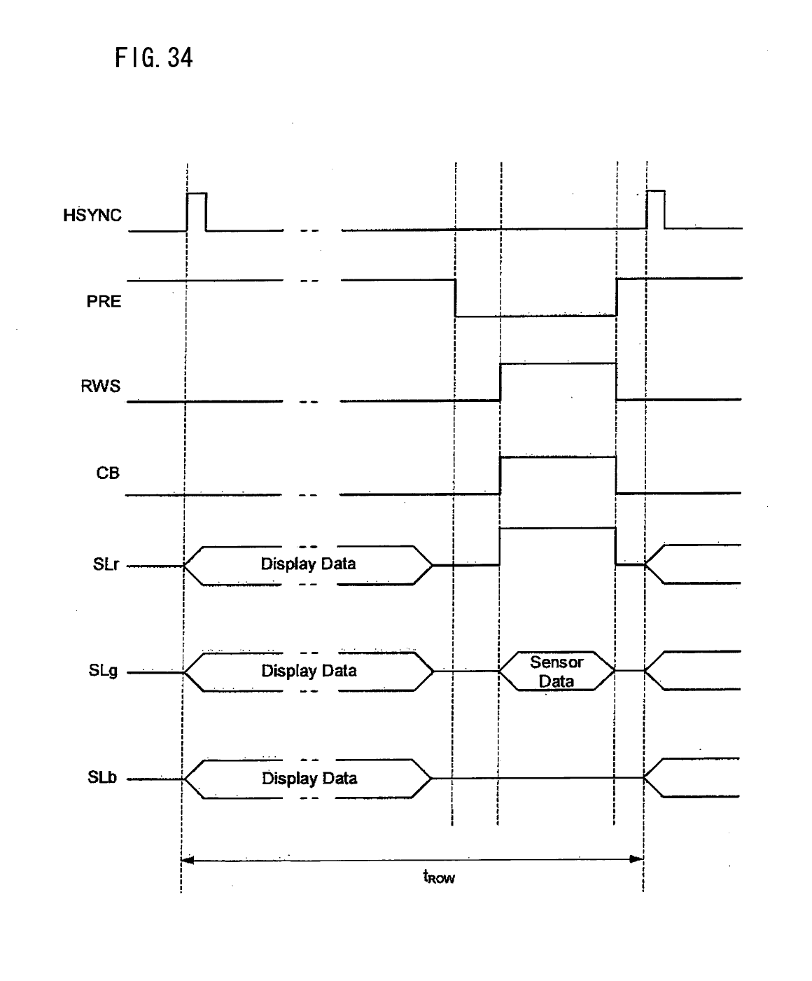

The source line sharing operation is now described with reference to FIG. 33 and FIG. 34. Display signal HSYNC denotes the start of the display row period, after which the source lines SLr, SLg and SLb are driven to a suitable value in order to control the state of the liquid crystal display element and output an image from the AMLCD.

The pixel gate line GL is now pulsed high under the control of the display gate driver such that the source line voltage is transferred to the adjacent pixel. After the display data has been written to the source lines and transferred to the pixel, the source lines are disconnected at the start of a display blanking period. This blanking period is a well-known technique common to AMLCD devices in which the counter electrode is periodically inverted.

During this display blanking period, the sensor row select signal is made high. Simultaneously, the display source line connected to the drain of the sensor pixel source follower amplifier transistor M1 is driven to V_{DD} and a bias voltage, V_{B}, is applied to gate of the sensor column bias transistor, M3 (during the display operation, V_{B}, is driven to a low potential such that M3 is turned off and does not interfere with the display operation). M1 and M3 now form a source follower amplifier, the output of which is indicative of the capacitance of the liquid crystal in the region of the sensor electrodes. Once the source follower output voltage has been read-out, the row select signal RWS and column bias signal CB are both returned to a low potential.

An advantage of this embodiment is the increase in aperture ratio relative to the previous embodiments that is associated with the sharing of display and sensor signal lines.

The arrangement of FIG. 33 is intended to be illustrative of the concept of integrating the active pixel sensor circuits described in this disclosure within an AMLCD pixel whereby the display and sensor elements share common lines. The sensor elements may be arranged in any suitable manner across a plurality of display pixels and need not therefore be confined to the arrangement shown in this diagram.

### Sixteenth Embodiment

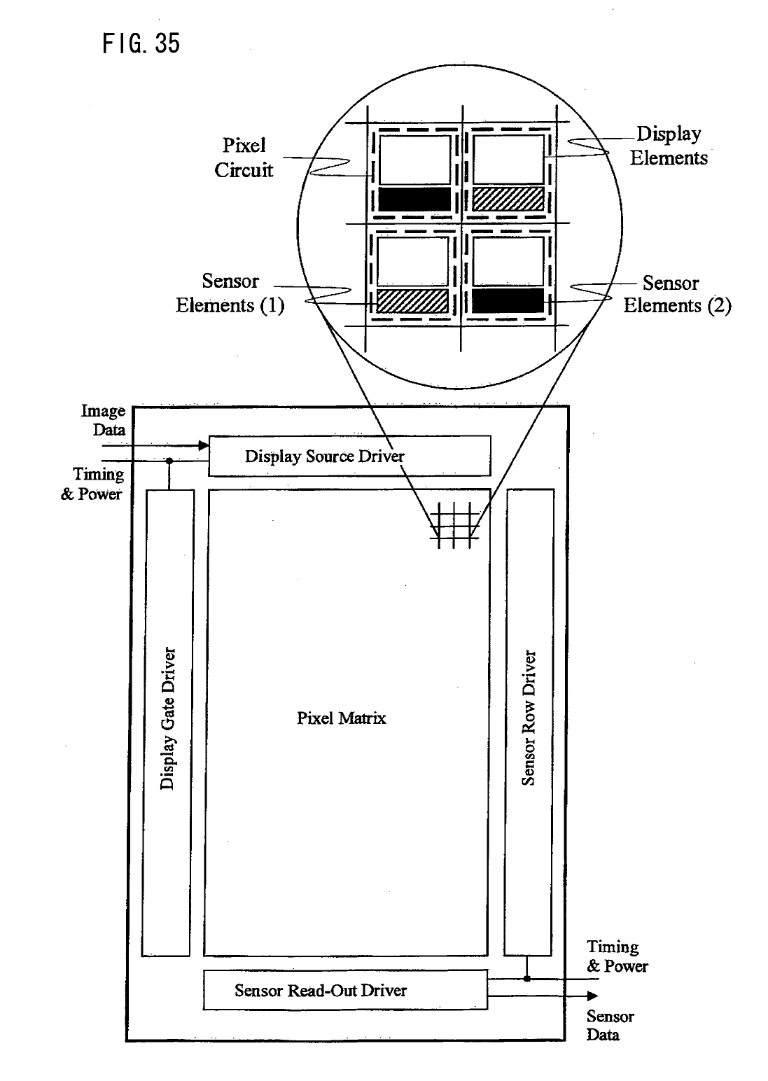

In the sixteenth embodiment of this invention, two or more different types of active pixel sensor circuits are integrated in a fixed pattern within the matrix of an AMLCD. Thus, the AMLCD comprises, in this embodiment, a first array of first sensor circuits and a third array of second sensor circuits, and may also comprise a second array of liquid crystal display pixels. The first sensor circuits and the second sensor circuits may be active pixel sensor circuits, and may be formed by any of the active pixel sensor circuits previously described in this disclosure and each type may exhibit a different sensitivity to input pressure (for example the second sensor circuits may have lower sensitivities compared to the first sensor circuits). Each active pixel sensor circuit may be integrated across a plurality of display pixels. For example, as shown in FIG. 35, a first active pixel sensor circuit of low sensitivity and a second active pixel sensor circuit of high sensitivity may be integrated in adjacent pixels of the display matrix such that the first sensor circuits are interleaved with the second sensor circuits.

A disadvantage of increasing the sensitivity of the capacitance sensor as described in the previous embodiments is that output voltage range of the sensor may be limited. Consequently, as the sensitivity is increased, the sensor output will saturate for an increasingly small input pressure. For a practical force sensitive touch panel in which the input object may range from an object with relatively small contact area, for example a stylus or pen, to an object with a relatively large contact area, for example a finger, and a large range of input forces is required, the range of pressures generated may exceed the range measurable by a single active pixel sensor circuit.

An advantage of this embodiment is that the range of the capacitance sensor array may be increased. In the example of FIG. 35, an input object of small contact area applying a high input touch force may be measured by the first active pixel sensor circuit, such as the standard active pixel sensor circuit described previously, whilst an input object of large contact area applying a small input force may be measured by the second active pixel sensor circuit, such as the active pixel sensor circuit of the twelfth embodiment of this invention.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

1. A liquid crystal device comprising a first array of first sensor circuits, each of which comprises an amplifier, a liquid crystal sensing capacitor connected between an input of the amplifier and a sensor circuit precharge input, and a further capacitor connected between the amplifier input and a sensor circuit selecting input.

2. A device as claimed in claim 1, in which the sensing capacitor comprises a planar capacitor having co-planar electrodes cooperating with an adjacent layer of liquid crystal material.

3. A device as claimed in claim 2, in which the co-planar electrodes face an electrode gap on an opposite side of the layer.

4. A device as claimed in claim 2, in which the co-planar electrodes face an electrically floating electrode on an opposite side of the layer.

5. A device as claimed in claim 2, in which the co-planar electrodes are surrounded by a co-planar guard ring arranged to receive a substantially fixed voltage.

6. A device as claimed in claim 1, in which the sensing capacitor has a capacitance which changes in response to a touch event.

7. A device as claimed in claim 1, in which the precharge input is arranged to receive a first voltage during a first precharge period and a second voltage whose value is less than that of the first voltage during a second precharge period.

8. A device as claimed in claim 1, in which the selecting input is arranged to receive a third voltage for inhibiting the first sensor circuit during an inhibiting period and a fourth voltage whose value is greater than that of the third voltage for enabling the first sensor circuit during an enabling period.

9. A device as claimed in claim 7, in which the selecting input is arranged to receive a third voltage for inhibiting the first sensor circuit during an inhibiting period and a fourth voltage whose value is greater than that of the third voltage for enabling the first sensor circuit during an enabling period, and the enabling period begins during the second precharge period.

10. A device as claimed in claim 9, in which the enabling period and the second precharge period end substantially simultaneously.

11. A device as claimed in claim 1, in which the amplifier comprises a first transistor.

12. A device as claimed in claim 11, in which the first transistor comprises a first metal oxide semiconductor field effect transistor.

13. A device as claimed in claim 12, in which the first transistor is connected as a source-follower.

14. A device as claimed in claim 13, in which the first array comprises rows and columns of the first sensor circuits with the source-followers of each column of the first sensor circuits being connected to a common source load.

15. A device as claimed in claim 14, in which the selecting inputs of the first sensor circuits of each row are connected together.

16. A device as claimed in claim 14, in which the precharge inputs of the first sensor circuits of each row are connected together.

17. A device as claimed in claim 1, in which the further capacitor comprises a voltage dependent capacitor.

18. A device as claimed in claim 17, in which the voltage dependent capacitor comprises a second metal oxide semiconductor field effect transistor.

19. A device as claimed in claim 18, in which a source and drain of the second field effect transistor are connected together.

20. A device as claimed in claim 1, in which each of the first sensor circuits comprises a diode having a first terminal connected to the amplifier input and arranged to provide a predetermined voltage at the amplifier input when the first sensor circuit is inhibited.

21. A device as claimed in claim 18, in which the second field effect transistor has a source-drain path connected between the amplifier input and a first terminal of a diode arranged to provide a predetermined voltage at the amplifier input when the first sensor circuit is inhibited.

22. A device as claimed in claim 20, in which a second terminal of the diode is connected to the precharge input.

23. A device as claimed in claim 1, comprising a second array of liquid crystal display pixels.

24. A device as claimed in claim 23, in which the first and second arrays are addressed by a common active matrix addressing arrangement.

25. A device as claimed in claim 24, in which the addressing arrangement is arranged to address the first array during display blanking periods.

26. A device as claimed in claim 23, in which the first sensor circuits have outputs connected to data input lines connected to pixel data inputs.

27. A device as claimed in, claim 23 in which each of the first sensor circuits is associated with a group of at least one of the pixels.

28. A device as claimed in claim 27, in which each group comprises a composite colour group of sub-pixels.

29. A device as claimed in claim 1, comprising a third array of second sensor circuits having sensitivities less than those of the first sensor circuits.

30. A device as claimed in claim 29, in which the second sensor circuits are interleaved with the first sensor circuits.

31. A device as claimed in claim 1 arranged to operate as a touch screen.
